(19) United States
(12) Patent Application Publication
(10) Pub. No.: US 2019/0340281 A1
(43) Pub. Date: Nov. 7, 2019

(54) SYSTEM AND METHOD FOR DYNAMIC SEARCH

(71) Applicant: NUTANIX, INC., San Jose, CA (US)

(72) Inventors: Atreyee Maiti, San Jose, CA (US); Bryan Crowe, San Jose, CA (US); Himanshu Shukla, San Jose, CA (US); Rahul Singh, San Jose, CA (US); Shamita Pisal, San Jose, CA (US); Shyan-Ming Perng, San Jose, CA (US); Ken Chen, San Francisco, CA (US); Binny Sher Gill, San Jose, CA (US); Satish Ramachandran, Sunnyvale, CA (US)

(21) Appl. No.: 15/970,103

(22) Filed: May 3, 2018

(51) Int. Cl. G06F 17/30; G06F 9/455

(52) U.S. Cl. CPC G06F 17/30448; G06F 17/30533; G06F 9/45558; G06F 17/30554; G06F 17/30663

(57) ABSTRACT

A system and method include receiving, by a search system of a virtual computing system, a search query via a search console, converting the search query into a structured query, and retrieving search results based on the structured query. The system and method further include activating a subset of widgets that satisfy a condition based on the search results and determining a view for each activated widget. Each widget is configured to display a particular type of the search results and the view for each widget is based upon a number of the search results of the particular type that the widget is configured to display. The system and method additionally include displaying the activated widget on the search console according to the view of that widget.

### BACKGROUND

The following description is provided to assist the understanding of the reader. None of the information provided or references cited is admitted to be prior art.

Virtual computing systems are widely used in a variety of applications. Virtual computing systems include one or more host machines running one or more virtual machines concurrently. The virtual machines utilize the hardware resources of the underlying host machines. Each virtual machine may be configured to run an instance of an operating system. Modern virtual computing systems allow several operating systems and several software applications to be safely run at the same time on the virtual machines of a single host machine, thereby increasing resource utilization and performance efficiency. However, the present day virtual computing systems have limitations due to their configuration and the way they operate.

### SUMMARY

In accordance with some aspects of the present disclosure, a method is disclosed. The method includes receiving, by a search system of a virtual computing system, a search query via a search console of the search system, converting, by the search system, the search query into a structured query, and retrieving, by the search system, search results based on the structured query. The method also includes activating, by the search system, a subset of widgets that satisfy a condition based on the search results and determining, by the search system, a view for each of the subset of widgets that are activated. Each of the subset of widgets is configured to display a particular type of the search results and the view for each of the subset of widgets is based upon a number of the search results of the particular type that the each of the subset of widgets is configured to display. The method further includes displaying, by the search system, the subset of widgets that are activated on the search console. The search results are displayed within each of the subset of widgets according to the view of the each of the subset of widgets.

In accordance with some other aspects of the present disclosure, a system is disclosed. The system includes a search system of a virtual computing system. The search system includes a search console configured to receive a search query from a user and a back-end system configured to receive the search query from the search console and cause search results corresponding to the search query to be displayed on the search console. The back-end system includes a database configured to store data associated with the search results and a processing unit. The processing unit is configured to receive the search query, convert the search query into a structured query, and retrieve the search results from the database based on the structured query. The processing unit is also configured to activate a subset of widgets that satisfy a condition based on the search results and determine a view for each of the subset of widgets that are activated. Each of the subset of widgets is configured to display a particular type of the search results and the view for each of the subset of widgets is based upon a number of the search results of the particular type that the each of the subset of widgets is configured to display. The processing unit is further configured to display the subset of widgets that are activated on the search console. The search results are displayed within each of the subset of widgets according to the view of the each of the subset of widgets.

In accordance with yet other aspects of the present disclosure, a non-transitory computer readable media with computer-executable instructions embodied thereon is disclosed. The instructions when executed by a processor of a search system of a virtual computing system cause the search system to perform a process. The process includes receiving a search query via a search console of the search system, converting the search query into a structured query, and retrieving search results based on the structured query. The process also includes activating a subset of widgets that satisfy a condition based on the search results and determining a view for each of the subset of widgets that are activated. Each of the subset of widgets is configured to display a particular type of the search results and the view for each of the subset of widgets is based upon a number of the search results of the particular type that the each of the subset of widgets is configured to display. The process further includes displaying the subset of widgets that are activated on the search console. The search results are displayed within each of the subset of widgets according to the view of the each of the subset of widgets.

The foregoing summary is illustrative only and is not intended to be in any way limiting. In addition to the illustrative aspects, embodiments, and features described above, further aspects, embodiments, and features will become apparent by reference to the following drawings and the detailed description.

### BRIEF DESCRIPTION OF THE DRAWINGS

FIG. 1 is an example block diagram of a virtual computing system, in accordance with some embodiments of the present disclosure.

FIG. 2 is another example block diagram of the virtual computing system of FIG. 1 showing a search system, in accordance with some embodiments of the present disclosure.

FIG. 3 is an example block diagram showing the search system of FIG. 2 in greater detail, in accordance with some embodiments of the present disclosure.

FIG. 4 is an example screenshot of a search console of the search system of FIG. 3, in accordance with some embodiments of the present disclosure.

FIG. 5 is an example flowchart outlining operations for making newly added services searchable by the search system of FIG. 3, in accordance with some embodiments of the present disclosure.

FIGS. 6A-6F are example screenshots showing the operations of FIG. 5, in accordance with some embodiments of the present disclosure.

FIG. 7 is an example block diagram of a content mapping system of the search system of FIG. 3, in accordance with some embodiments of the present disclosure.

FIG. 8 is an example flowchart outlining operations performed by the content mapping system of FIG. 7 for determining which widgets to present on the search console of the search system and the manner of displaying content on the presented widgets, in accordance with some embodiments of the present disclosure.

FIG. 9 is an example flowchart outlining operations performed by the content mapping system of FIG. 7 for determining the manner of displaying content on the presented widgets, in accordance with some embodiments of the present disclosure.

FIGS. 10A-10C are example screenshots showing the various manners of displaying the content on the presented widgets, in accordance with some embodiments of the present disclosure.

The foregoing and other features of the present disclosure will become apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and make part of this disclosure.

The present disclosure is generally directed to a virtual computing system having a plurality of clusters, with each cluster having a plurality of nodes. Each of the plurality of nodes includes one or more virtual machines managed by an instance of a hypervisor. These and other various components within the virtual computing system may be part of a datacenter and may be managed by a user (e.g., an administrator or other authorized personnel). The virtual computing system also includes a search system that is configured to receive search queries from the user and return search results to the user corresponding to those search queries. The search results include data from various components of the virtual computing system that are associated with the search system.

The search system may be used for managing the virtual computing system, and by extension, managing the datacenter of which the virtual computing system forms a part. Managing the virtual computing system and the datacenter may include troubleshooting or identifying (and resolving) problems (e.g., components running slow, components failing, etc.) that may be impacting the virtual computing system and the datacenter, updating (e.g., upgrading) components within the virtual computing system and the datacenter, or otherwise performing a variety of tasks that keep the virtual computing system and the datacenter in an up-to-date normal operational state. By using the search system, the user may run search queries to retrieve data associated with the various components that are to be managed, and manage the various components in accordance with the retrieved data.

The size of the datacenter has been steadfastly growing-more and more components are being added to virtual computing systems of the datacenter on a regular basis. For example, virtual computing systems that previously included hundreds of virtual machines may now have thousands of virtual machines. As the size of the virtual computing systems, and therefore, the size of the datacenter increases, the management of the datacenter is becoming more and more challenging, and conventional search systems that are used for managing those datacenters are unable to keep up with the rapidly increasing datacenter sizes.

For example, conventionally, as new services (e.g., components) are added to the datacenter, those new services are not automatically associated with the search system. Without being associated with the search system, search results do not include data from the new services. Without including data from the new services, management of those new services becomes difficult and challenging. To include data from the new services in the search results, conventionally, the user has to manually associate the new services with the search system. This is not only cumbersome, it is time consuming, diverts the attention of the user from more pressing tasks, and prevents optimal operation of the search system and the management of the datacenter. Thus, a technical problem currently exists in which the search system does not scale with the size of the datacenter to automatically include new services.

Even after the new services have been associated with the search system, with increasing sizes of the datacenter, the volume of data that is retrieved as part of the search results is rapidly growing. For example, search results that previously may have included data from hundreds of virtual machines now includes data from thousands of virtual machines. Thus, the sheer volume of data that is retrieved may overwhelm the user. Reviewing such a large amount of data is again time consuming, cumbersome, and the relevant piece of data may be buried and difficult or practically impossible to find. Thus, proper management of the datacenter is increasingly becoming more and more complex, and the search system designed to facilitate the management is failing to serve its intended purpose. Accordingly, additional technical problems currently exist in which the conventional search system provides an unmanageable volume of data that is not conducive to the proper management of the datacenter.

The present disclosure provides solutions. Specifically, the present disclosure provides a search system, which is dynamic and scales appropriately with growing datacenter sizes. The search system is also configured to analyze and organize the search results in a form that is manageable and easy for the user to follow and understand. Specifically, the search system of the present disclosure provides a mechanism via which newly added services are automatically associated with the search system. Once associated with the search system, data from the newly added services is automatically included in the search results, without requiring specific intervention from the user. Thus, the search system of the present disclosure automatically adapts to increasing sizes of the datacenter in an easy, convenient, and effective manner.

Additionally, the search system of the present disclosure is configured to vary the manner in which the search results are displayed to the user. Specifically, the search system is configured to identify or at least predict the intent of the user in running the search query and return search results that are aligned with that intent. Thus, the search system returns search results that are more likely to be useful to the user and less likely to be buried within irrelevant data. Additionally, the search system organizes the search results that are returned in a manner that facilitates easy review of data and management of the datacenter. For example, the search system is programmed with certain conditions which help identify how to display the search results to the user.

The manner in which the search results are displayed is based at least on a number of search results of a particular type. Specifically, if the search results include a large number of search results of a particular type, the search system displays the search results in a manner that would be different if the search results only had a small number of or even a single search result of that particular type. For example, when the search results include a single search result of a particular type (e.g., a single alert related search result), the search system provides a detailed view of the search result that includes additional information pertaining to the search result. On the other hand, if the search results include a large number of search results of a particular type, then the search system combines those search results in a visual view (e.g., a graph) that provides an overview of the search results. The visual view is configured such that the user may expand one or more search results from the visual view to see additional information. Likewise, if the search results include a small number of search results of a particular type, the search system displays the search results in a list form (e.g., a table) that provides less information than a detailed view but more information than a visual view. Thus, the search system adapts to the size of the datacenter by sorting search results and varying the manner of displaying the search results.

By dynamically adapting to the size of the datacenter, the search system of the present disclosure is able to operate optimally in facilitating the management of the datacenter, and therefore, overcomes the disadvantages of conventional search systems.

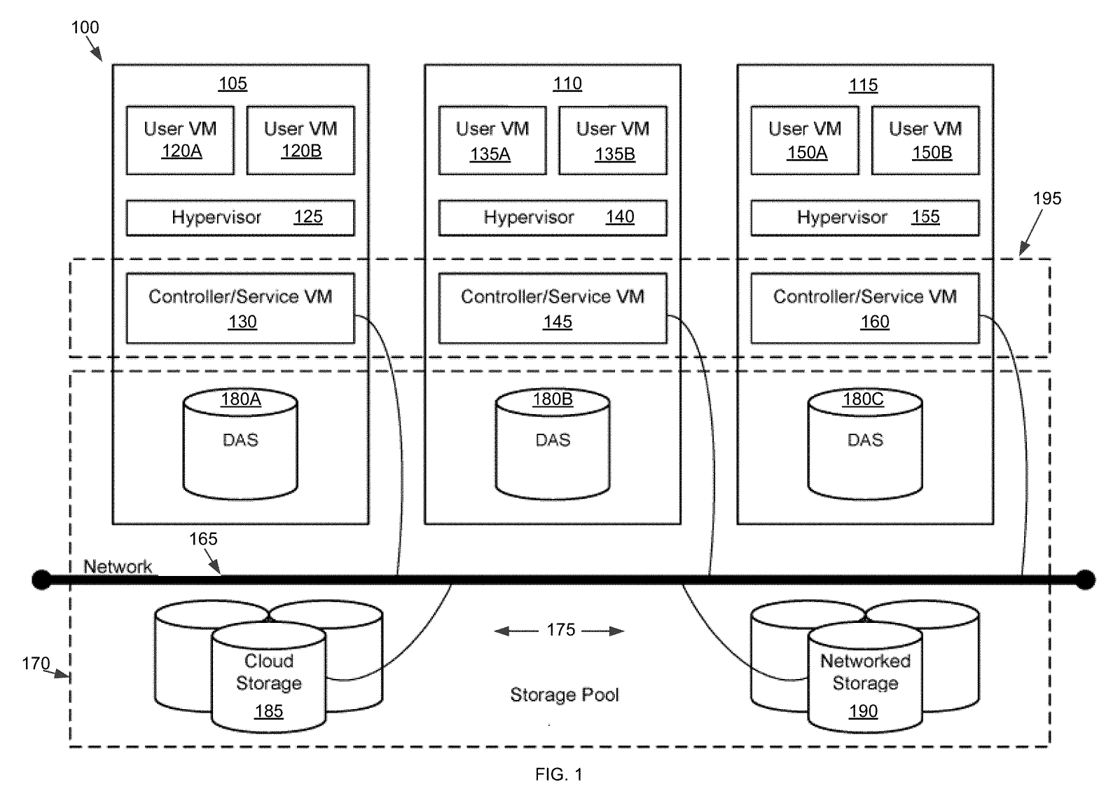

Referring now to FIG. 1, a virtual computing system 100 is shown, in accordance with some embodiments of the present disclosure. The virtual computing system 100 includes a plurality of nodes, such as a first node 105, a second node 110, and a third node 115. Each of the first node 105, the second node 110, and the third node 115 may also be referred to as a “host” or “host machine.” The first node 105 includes user virtual machines (“user VMs”) 120A and 120B (collectively referred to herein as “user VMs 120”), a hypervisor 125 configured to create and run the user VMs, and a controller/service VM 130 configured to manage, route, and otherwise handle workflow requests between the various nodes of the virtual computing system 100. Similarly, the second node 110 includes user VMs 135A and 135B (collectively referred to herein as “user VMs 135”), a hypervisor 140, and a controller/service VM 145, and the third node 115 includes user VMs 150A and 150B (collectively referred to herein as “user VMs 150”), a hypervisor 155, and a controller/service VM 160. The controller/service VM 130, the controller/service VM 145, and the controller/service VM 160 are all connected to a network 165 to facilitate communication between the first node 105, the second node 110, and the third node 115. Although not shown, in some embodiments, the hypervisor 125, the hypervisor 140, and the hypervisor 155 may also be connected to the network 165.

The virtual computing system 100 also includes a storage pool 170. The storage pool 170 may include network-attached storage 175 and direct-attached storage 180A, 180B, and 180C. The network-attached storage 175 is accessible via the network 165 and, in some embodiments, may include cloud storage 185, as well as local storage area network 190. In contrast to the network-attached storage 175, which is accessible via the network 165, the direct-attached storage 180A, 180B, and 180C includes storage components that are provided within each of the first node 105, the second node 110, and the third node 115, respectively, such that each of the first, second, and third nodes may access its respective direct-attached storage without having to access the network 165.

It is to be understood that only certain components of the virtual computing system 100 are shown in FIG. 1. Nevertheless, several other components that are needed or desired in the virtual computing system 100 to perform the functions described herein are contemplated and considered within the scope of the present disclosure. Some additional features of the virtual computing system 100 are described in U.S. Pat. No. 8,601,473, the entirety of which is incorporated by reference herein.

Although three of the plurality of nodes (e.g., the first node 105, the second node 110, and the third node 115) are shown in the virtual computing system 100, in other embodiments, greater than or fewer than three nodes may be used. Likewise, although only two of the user VMs (e.g., the user VMs 120, the user VMs 135, and the user VMs 150) are shown on each of the respective first node 105, the second node 110, and the third node 115, in other embodiments, the number of the user VMs on each of the first, second, and third nodes may vary to include either a single user VM or more than two user VMs. Further, the first node 105, the second node 110, and the third node 115 need not always have the same number of the user VMs (e.g., the user VMs 120, the user VMs 135, and the user VMs 150).

In some embodiments, each of the first node 105, the second node 110, and the third node 115 may be a hardware device, such as a server. For example, in some embodiments, one or more of the first node 105, the second node 110, and the third node 115 may be an NX-1000 server, NX-3000 server, NX-6000 server, NX-8000 server, etc. provided by Nutanix, Inc. or server computers from Dell, Inc., Lenovo Group Ltd. or Lenovo PC International, Cisco Systems, Inc., etc. In other embodiments, one or more of the first node 105, the second node 110, or the third node 115 may be another type of hardware device, such as a personal computer, an input/output or peripheral unit such as a printer, or any type of device that is suitable for use as a node within the virtual computing system 100. In some embodiments, the virtual computing system 100 may be part of a data center.

Each of the first node 105, the second node 110, and the third node 115 may also be configured to communicate and share resources with each other via the network 165. For example, in some embodiments, the first node 105, the second node 110, and the third node 115 may communicate and share resources with each other via the controller/service VM 130, the controller/service VM 145, and the controller/service VM 160, and/or the hypervisor 125, the hypervisor 140, and the hypervisor 155. One or more of the first node 105, the second node 110, and the third node 115 may be organized in a variety of network topologies.

Also, although not shown, one or more of the first node 105, the second node 110, and the third node 115 may include one or more processing units configured to execute instructions. The instructions may be carried out by a special purpose computer, logic circuits, or hardware circuits of the first node 105, the second node 110, and the third node 115. The processing units may be implemented in hardware, firmware, software, or any combination thereof. The term “execution” is, for example, the process of running an application or the carrying out of the operation called for by an instruction. The instructions may be written using one or more programming language, scripting language, assembly language, etc. The processing units, thus, execute an instruction, meaning that they perform the operations called for by that instruction.

The processing units may be operably coupled to the storage pool 170, as well as with other elements of the first node 105, the second node 110, and the third node 115 to receive, send, and process information, and to control the operations of the underlying first, second, or third node. The processing units may retrieve a set of instructions from the storage pool 170, such as, from a permanent memory device like a read only memory (“ROM”) device and copy the instructions in an executable form to a temporary memory device that is generally some form of random access memory (“RAM”). The ROM and RAM may both be part of the storage pool 170, or in some embodiments, may be separately provisioned from the storage pool. Further, the processing units may include a single stand-alone processing unit, or a plurality of processing units that use the same or different processing technology.

With respect to the storage pool 170 and particularly with respect to the direct-attached storage 180A, 180B, and 180C, each of the direct-attached storage may include a variety of types of memory devices. For example, in some embodiments, one or more of the direct-attached storage 180A, 180B, and 180C may include, but is not limited to, any type of RAM, ROM, flash memory, magnetic storage devices (e.g., hard disk, floppy disk, magnetic strips, etc.), optical disks (e.g., compact disk (“CD”), digital versatile disk (“DVD”), etc.), smart cards, solid state devices, etc. Likewise, the network-attached storage 175 may include any of a variety of network accessible storage (e.g., the cloud storage 185, the local storage area network 190, etc.) that is suitable for use within the virtual computing system 100 and accessible via the network 165. The storage pool 170, including the network-attached storage 175 and the direct-attached storage 180A, 180B, and 180C, together form a distributed storage system configured to be accessed by each of the first node 105, the second node 110, and the third node 115 via the network 165, the controller/service VM 130, the controller/service VM 145, the controller/service VM 160, and/or the hypervisor 125, the hypervisor 140, and the hypervisor 155. In some embodiments, the various storage components in the storage pool 170 may be configured as virtual disks for access by the user VMs 120, the user VMs 135, and the user VMs 150.

Each of the user VMs 120, the user VMs 135, and the user VMs 150 is a software-based implementation of a computing machine in the virtual computing system 100. The user VMs 120, the user VMs 135, and the user VMs 150 emulate the functionality of a physical computer. Specifically, the hardware resources, such as processing unit, memory, storage, etc., of the underlying computer (e.g., the first node 105, the second node 110, and the third node 115) are virtualized or transformed by the respective hypervisor 125, the hypervisor 140, and the hypervisor 155, into the underlying support for each of the user VMs 120, the user VMs 135, and the user VMs 150 that may run its own operating system and applications on the underlying physical resources just like a real computer. By encapsulating an entire machine, including CPU, memory, operating system, storage devices, and network devices, the user VMs 120, the user VMs 135, and the user VMs 150 are compatible with most standard operating systems (e.g. Windows, Linux, etc.), applications, and device drivers. Thus, each of the hypervisor 125, the hypervisor 140, and the hypervisor 155 is a virtual machine monitor that allows a single physical server computer (e.g., the first node 105, the second node 110, third node 115) to run multiple instances of the user VMs 120, the user VMs 135, and the user VMs 150, with each user VM sharing the resources of that one physical server computer, potentially across multiple environments. By running the user VMs 120, the user VMs 135, and the user VMs 150 on each of the first node 105, the second node 110, and the third node 115, respectively, multiple workloads and multiple operating systems may be run on a single piece of underlying hardware computer (e.g., the first node, the second node, and the third node) to increase resource utilization and manage workflow.

The user VMs 120, the user VMs 135, and the user VMs 150 are controlled and managed by their respective instance of the controller/service VM 130, the controller/service VM 145, and the controller/service VM 160. The controller/service VM 130, the controller/service VM 145, and the controller/service VM 160 are configured to communicate with each other via the network 165 to form a distributed system 195. Each of the controller/service VM 130, the controller/service VM 145, and the controller/service VM 160 may also include a local management system (e.g., Prism Element from Nutanix, Inc.) configured to manage various tasks and operations within the virtual computing system 100. For example, in some embodiments, the local management system may perform various management related tasks on the user VMs 120, the user VMs 135, and the user VMs 150.

The hypervisor 125, the hypervisor 140, and the hypervisor 155 of the first node 105, the second node 110, and the third node 115, respectively, may be configured to run virtualization software, such as, ESXi from VMWare, AHV from Nutanix, Inc., XenServer from Citrix Systems, Inc., etc. The virtualization software on the hypervisor 125, the hypervisor 140, and the hypervisor 155 may be configured for running the user VMs 120, the user VMs 135, and the user VMs 150, respectively, and for managing the interactions between those user VMs and the underlying hardware of the first node 105, the second node 110, and the third node 115. Each of the controller/service VM 130, the controller/service VM 145, the controller/service VM 160, the hypervisor 125, the hypervisor 140, and the hypervisor 155 may be configured as suitable for use within the virtual computing system 100.

The network 165 may include any of a variety of wired or wireless network channels that may be suitable for use within the virtual computing system 100. For example, in some embodiments, the network 165 may include wired connections, such as an Ethernet connection, one or more twisted pair wires, coaxial cables, fiber optic cables, etc. In other embodiments, the network 165 may include wireless connections, such as microwaves, infrared waves, radio waves, spread spectrum technologies, satellites, etc. The network 165 may also be configured to communicate with another device using cellular networks, local area networks, wide area networks, the Internet, etc. In some embodiments, the network 165 may include a combination of wired and wireless communications.

Referring still to FIG. 1, in some embodiments, one of the first node 105, the second node 110, or the third node 115 may be configured as a leader node. The leader node may be configured to monitor and handle requests from other nodes in the virtual computing system 100. For example, a particular user VM (e.g., the user VMs 120, the user VMs 135, or the user VMs 150) may direct an input/output request to the controller/service VM (e.g., the controller/service VM 130, the controller/service VM 145, or the controller/service VM 160, respectively) on the underlying node (e.g., the first node 105, the second node 110, or the third node 115, respectively). Upon receiving the input/output request, that controller/service VM may direct the input/output request to the controller/service VM (e.g., one of the controller/service VM 130, the controller/service VM 145, or the controller/service VM 160) of the leader node. In some cases, the controller/service VM that receives the input/output request may itself be on the leader node, in which case, the controller/service VM does not transfer the request, but rather handles the request itself.

The controller/service VM of the leader node may fulfil the input/output request (and/or request another component within the virtual computing system 100 to fulfil that request). Upon fulfilling the input/output request, the controller/service VM of the leader node may send a response back to the controller/service VM of the node from which the request was received, which in turn may pass the response to the user VM that initiated the request. In a similar manner, the leader node may also be configured to receive and handle requests (e.g., user requests) from outside of the virtual computing system 100. If the leader node fails, another leader node may be designated.

Furthermore, one or more of the first node 105, the second node 110, and the third node 115 may be combined together to form a network cluster (also referred to herein as simply “cluster.”) Generally speaking, all of the nodes (e.g., the first node 105, the second node 110, and the third node 115) in the virtual computing system 100 may be divided into one or more clusters. One or more components of the storage pool 170 may be part of the cluster as well. For example, the virtual computing system 100 as shown in FIG. 1 may form one cluster in some embodiments. Multiple clusters may exist within a given virtual computing system (e.g., the virtual computing system 100). The user VMs 120, the user VMs 135, and the user VMs 150 that are part of a cluster are configured to share resources with each other. In some embodiments, multiple clusters may share resources with one another.

Additionally, in some embodiments, although not shown, the virtual computing system 100 includes a central management system (e.g., Prism Central from Nutanix, Inc.) that is configured to manage and control the operation of the various clusters in the virtual computing system. In some embodiments, the central management system may be configured to communicate with the local management systems on each of the controller/service VM 130, the controller/service VM 145, the controller/service VM 160 for controlling the various clusters.

Again, it is to be understood again that only certain components and features of the virtual computing system 100 are shown and described herein. Nevertheless, other components and features that may be needed or desired to perform the functions described herein are contemplated and considered within the scope of the present disclosure. It is also to be understood that the configuration of the various components of the virtual computing system 100 described above is only an example and is not intended to be limiting in any way. Rather, the configuration of those components may vary to perform the functions described herein.

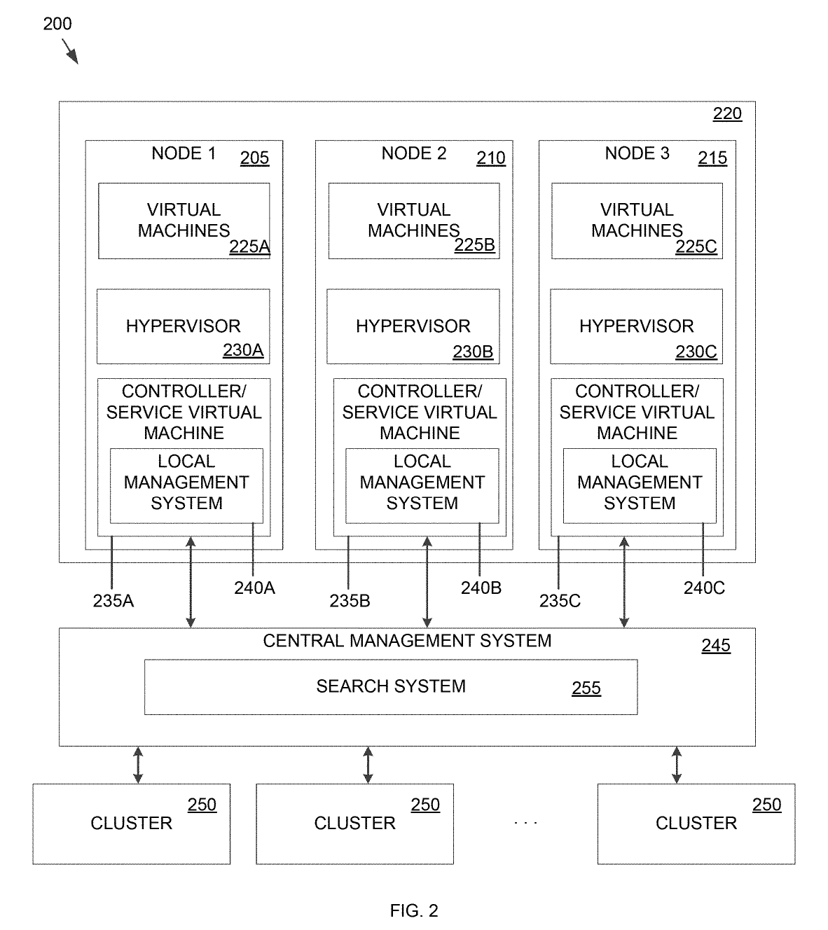

Turning to FIG. 2, another block diagram of a virtual computing system 200 is shown, in accordance with some embodiments of the present disclosure. The virtual computing system 200 is analogous to, albeit a simplified version, of the virtual computing system 100. Thus, although only some of the components have been shown in the virtual computing system 200, the virtual computing system is intended to include other components and features, as discussed above with respect to the virtual computing system 100. The virtual computing system 200 includes a first node 205, a second node 210, and a third node 215, all of which form part of a cluster 220. Although only three nodes (e.g., the first node 205, the second node 210, and the third node 215) have been shown in the cluster 220, the number of nodes may vary to be greater than or fewer than three.

The first node 205 includes virtual machines 225A, the second node 210 includes virtual machines 225B, and the third node 215 includes virtual machines 225C. Additionally, the first node 205 includes a hypervisor 230A and a controller/service virtual machine 235A. Similarly, the second node 210 includes a hypervisor 230B, and a controller/service virtual machine 235B, while the third node 215 includes a hypervisor 230C, and a controller/service virtual machine 235C. Further, each of the controller/service virtual machine 235A, controller/service virtual machine 235B, and controller/service virtual machine 235C respectively include a local management system 240A, a local management system 240B, and a local management system 240C. The local management system 240A, the local management system 240B, and the local management system 240C, in some embodiments, is the Prism Element component from Nutanix, Inc., and may be configured to perform a variety of management tasks on the underlying node (e.g., the first node 205, the second node 210, and the third node 215, respectively).

The virtual computing system 200 also includes a central management system (also referred to herein as “overall management system”) 245. The central management system 245, in some embodiments, is the Prism Central component from Nutanix, Inc. that is configured to manage all of the clusters (e.g., including the cluster 220 and clusters 250) within the virtual computing system 200. In some embodiments, to manage a particular cluster (e.g., the cluster 220), the central management system 245 may communicate with the local management system 240A, the local management system 240B, and the local management system 240C of the cluster 220 for managing the various components of that cluster. In other embodiments, the central management system 245 may communicate with the local management system (e.g., the local management system 240A, the local management system 240B, or the local management system 240C) on the leader node or a local management system designated to communicate with the central management system, which in turn may then communicate with other components within the cluster (e.g., the cluster 220) to perform operations requested by the central management system. Similarly, the central management system 260 may communicate with the local management systems of the nodes of the clusters 250 in the virtual computing system 200 for managing those clusters.

The central management system 245 also includes a search system 255. The search system 255 is configured to receive search queries from a user and provide results back to the user in response to the received search queries. The search results includes data received back from components (also referred to herein as “entities” or “services”) of the cluster 220 and the clusters 250 that are connected to and communicating with the search system 255. As discussed in greater detail below, the search system 255 is a dynamic search system in which the search results that are returned to the user vary based upon a current state of the virtual computing system 200, the size of the virtual computing system (e.g., the number of components that are within the virtual computing system), and/or a number of search results of a particular type that are retrieved.

Although the search system 255 has been shown as being part of the central management system 245, in some embodiments, the search system may be part of one or more of the local management systems (e.g., the local management system 240A, the local management system 240B, and the local management system 240C). In yet other embodiments, an instance of the search system 255 may be on the central management system 245 and another instance of the search system may be on one or more of the local management systems (e.g., the local management system 240A, the local management system 240B, and the local management system 240C). In some embodiments, certain features of the search system 255 may be made available on the central management system 245 and other features may be made available on one or more of the local management systems (e.g., the local management system 240A, the local management system 240B, and the local management system 240C). Thus, the search system 255 may be configured in a variety of ways.

Again, notwithstanding the components of the virtual computing system 200 shown and described herein, in other embodiments, the virtual computing system 200 is intended to include other components and features, as described above with respect to the virtual computing system 100.

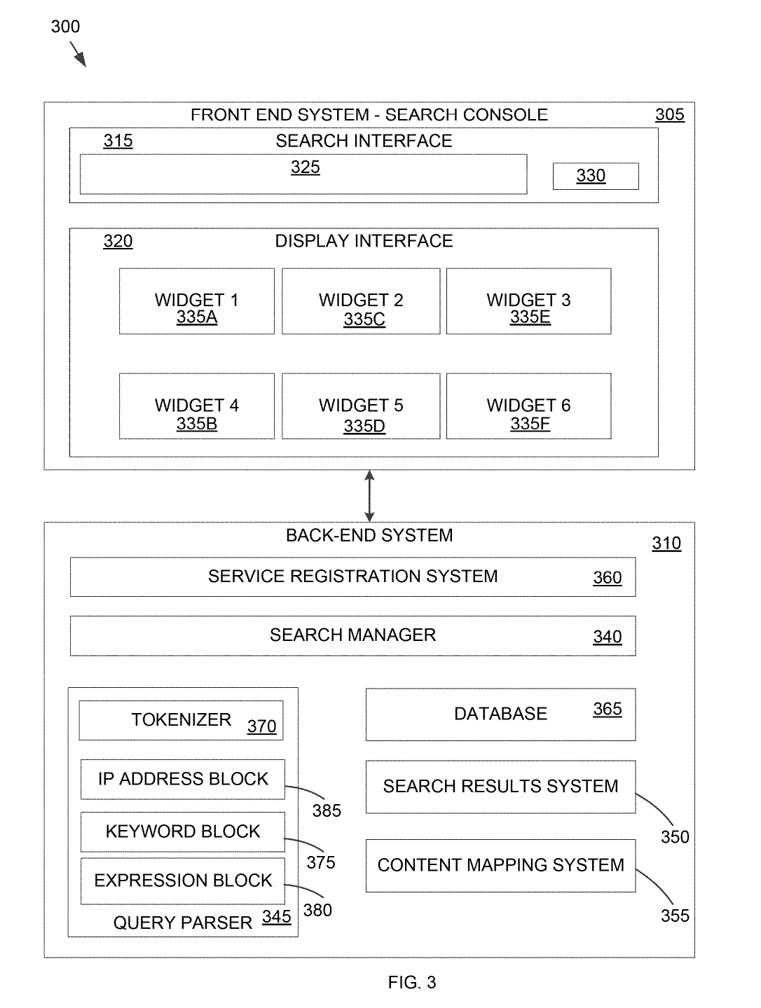

Turning now to FIG. 3, an example block diagram of a search system 300 is shown, in accordance with some embodiments of the present disclosure. The search system 300 is configured to receive search queries and return search results associated with various entities within the virtual computing system (e.g., the virtual computing system 100 and the virtual computing system 200). An “entity” as used herein means clusters, nodes, virtual machines, virtual disks, software applications, and other hardware, software, storage, virtual clouds, and data center components that make up a virtual computing system (e.g., the virtual computing system 100 and the virtual computing system 200). The search system 300 is a contextual search system that identifies the context of a search query and particularly, identifies or predicts the intent of the user in running the search query. The search system 300 may identify the intent of the user by analyzing the search query, as detailed below, to determine whether the user is in a troubleshooting mode, exploration mode, a management mode, or another type of work flow mode. The search system 300 may return results back based upon the identified intent of the user.

The search system 300 includes a front-end system, namely, a search console 305 that is viewable by the user and is configured to receive search queries from the user. The search console 305 is also configured to return search results back to the user in response to the search queries. The search system 300 also includes a back-end system 310 that is not visible to the user, but is rather configured to receive the search queries received via the search console 305 and return the search results corresponding to the search queries for displaying on the search console.

In some embodiments, the search system 300 may be installed on a device associated with the central management system (e.g., the central management system 245) and/or the local management system (e.g., the local management system 240A, the local management system 240B, or the local management system 240C). In some embodiments, the search system 300 may be accessed physically from the device on which the search system installed. In other embodiments, the search system 300 may additionally or alternatively be configured for access via an application programming interface (“API”). In such cases, users may access the search system 300 via designated devices such as laptops, desktops, tablets, mobile devices, other handheld or portable devices, and/or other types of computing devices that are configured to access the API. These devices may be different from the device on which the search system 300 is installed. The API provides an interface with a set of routines, protocols, and tools to allow users to access the search system 300. In some embodiments, the API may be a representational state transfer (“REST”) type of API. In other embodiments, the API may be any other type of web or other type of API (e.g., ASP.NET) built using any of a variety of technologies, such as Java, .Net, etc., that is capable of accessing the search system 300 and facilitating communication between the users and the search system.

In some embodiments, the API may be configured to facilitate communication between the users and the search system 300 via a hypertext transfer protocol (“HTTP”) or hypertext transfer protocol secure (“HTTPS”) type request. The API may receive an HTTP/HTTPS request and send an HTTP/HTTPS response back. In other embodiments, the API may be configured to facilitate communication between the users and the search system 300 using other or additional types of communication protocols. In some embodiments and when the search system 300 is configured for use via an API, the users may access the search console 305 of the search system via a web browser and upon entering a uniform resource locator (“URL”) for the API. Using the API, the users may then send search queries to the back-end system 310 and receive search results from the back-end system.

In other embodiments, instead of or in addition to being installed on a particular device as discussed above, the search system 300 may be hosted on a cloud service and may be accessed via the cloud using an API or other mechanism. In some embodiments, the search system 300 may additionally or alternatively be configured as a mobile application that is suitable for installing on and access from a mobile computing device (e.g., a mobile phone). In other embodiments, the search system 300 may be configured for user access in other ways.

As indicated above, the search system 300 includes the search console 305. The search console 305 is a user interface that facilitates human-computer interaction between the users and the search system 300. Thus, the search console 305 is configured to receive search queries (and other user inputs) from the users and transmit those search queries (and other user inputs) to the back-end system 310. The search console 305 is also configured to receive outputs from the back-end system 310 and present those outputs to the users via the search console. In some embodiments, the search console 305 is configured as a graphical user interface (“GUI”). The GUI may present a variety of graphical icons, visual indicators, menus, visual widgets, and other indicia to facilitate user interaction. In other embodiments, the search console 305 may be configured as other types of user interfaces, including for example, text-based user interfaces, man-machine interfaces, etc. In some embodiments, a portion of the search console 305 may be configured as one type of user interface (e.g., GUI), while another portion of the search console may be configured as another type of user interface (e.g., text-based). Thus, the search console 305 may be configured in a variety of ways.

Further, the search console 305 may be configured to receive the search queries (and other user inputs) in a variety of ways. For example, the search console 305 may be configured to receive the search queries (and the other user inputs) using input technologies including, but not limited to, a keyboard, a stylus and/or touch screen, a mouse, a track ball, a keypad, a microphone, voice recognition, motion recognition, remote controllers, input ports, one or more buttons, dials, joysticks, etc. that allow an external source, such as the user, to enter information into the search console. The search console 305 may also be configured to present outputs from the back-end system 310 to the users in a variety of ways. For example, the search console 305 may be configured to present information to external systems such as users, memory, printers, speakers, etc.

Therefore, although not shown, the search console 305 may be associated with a variety of hardware, software, firmware components, or combinations thereof. Generally speaking, the search console 305 may be associated with any type of hardware, software, and/or firmware component that enables the search console to perform the functions described herein.

Additionally, the search console 305 may be configured to present information to the users in one or more “windows.” A “window” as used herein means a graphical control element that provides a frame or visual area for presenting data or features in the form of web pages, messages, graphs, etc. The users may interact with the data or features in the windows to send user inputs and receive outputs. Such interactions may open new windows, replace old windows with new windows, etc. When a new window is opened, that new window may overlap the old window, open as a new tab, etc. Thus, the manner in which the search console 305 is configured to display information may vary from one embodiment to another.

The search console 305 includes a search interface 315 and a display interface 320. In some embodiments, the search interface 315 and the display interface 320 may be displayed within separate windows that are both visible to the user at the same time or within the same windows in different areas (as shown in FIG. 3). It is to be understood that the placement and design (e.g., shape, size, font, orientation, etc.) of the search interface 315 and the display interface 320 as shown in FIG. 3 and described herein are only examples and not intended to be limiting in any way. Rather, the placement and design of the search interface 315, the display interface 320, and/or other features of the search console 305 may vary from one embodiment to another.

The search interface 315 includes a search box 325 to receive search queries from the user and a search button 330 to send the search queries to the back-end system 310. Specifically, the user inputs a search query into the search box 325 and interacts with (e.g., click, press-and-hold, roll or hover over, etc.) the search button 330 to send the search query to the back-end system 310 for further processing and retrieval of search results. Thus, the search interface 315 is configured to start a search process. The back-end system 310 retrieves the search results and displays those search results on the display interface 320.

The search interface 315 and particularly, the search box 325, is configured to receive a variety of configurations of the search query. For example, in some embodiments, the search interface 315 may be configured to receive a search query entered in the form of keywords. Keywords are pre-defined terms or phrases that are understood by the search system 300. A list of all keywords understood by the search system 300 may be stored within a database (e.g., the storage pool 170) that is accessible to the search system. The list of keywords may also be made available to the user.

Each keyword may be classified into one or more of four categories: entity type, properties, identifiers, and actions. “Entity type” keywords include the different types of entities, such as, clusters, nodes, virtual machines, virtual disks, software applications, and other hardware, software, storage, virtual clouds, and data center components that make up the virtual computing system (e.g., the virtual computing system 100 and the virtual computing system 200). Each “entity type” may include one or more “entities.” For example, in FIG. 1, each of the first node 105, the second node 110, and the third node 115 is an “entity” of “entity type” host machine.

“Properties” keywords include various attributes, values of attributes, and metrics/metric names associated with each entity type and/or entity. For example, each entity type may include one or more “properties” that may be same as, similar to, or different from the “properties” of the other entity types. In some embodiments, all of the entities included within a specific entity type may have the same properties. In other embodiments, the entities for a specific entity type may have at least some varying properties. Examples of “properties” keywords may include attributes such as type of operating system, number of processing units, number of storage units, IP address, etc. As noted above, “properties” keywords also include various metrics, such as processing unit utilization, disk space, latency, etc. Thus, the “properties” keywords identify the various hardware, software, and firmware features and characteristics of each entity and entity type.

“Identifiers” keywords may include identification information that may be used to uniquely identify an entity and/or entity type. For example, the “identifiers” keywords may include entity name (e.g., host name, cluster name, etc.), entity version, or any other identifying information that may be used to uniquely identify and distinguish one entity and/or entity type from another entity and/or entity type within a cluster.

“Actions” keywords include any actions that a particular entity and/or entity type may be authorized to perform. For example, “actions” keywords may include create, modify, delete, add, etc. that an entity and/or entity type may perform. The “actions” keywords may also include various work flow related tasks such as data recovery, capacity management, etc. that an entity and/or entity type may perform.

In addition to simple keywords, in some embodiments, the user may enter the search query in the form of an expression. Expressions may include phrases or keywords that are separated by an operator. The operator may be a symbol (e.g., =, >, <, etc.) or a subjective keyword (e.g., slow, high, low, top, greater than, less than, equal to, etc.). In some embodiments, the operator may also include advanced filter values (e.g., contains, does not contain, etc.). A valid expression includes a left hand side term and a right hand side term separated by the operator. In some embodiments, the left hand side term may be a keyword or a commonly used, “human friendly,” word. The right hand side term may be a value of the left hand side term. For example, an expression could be “version=5.0.” In this example, the left hand side term, “version,” may be a recognized keyword (or a commonly used term that may be translated into a recognized keyword by the search system 300) and the right hand side term, “5.0,” is a value of the left hand side term, “version.” Similar to the keywords, a list of all recognized operators may be stored within a database and be accessible to the search system 300.

In some other embodiments, the user may enter an Internet Protocol (IP) address as the search query. In yet other embodiments, the user may simply use “human friendly” words to construct the search query, which may then be translated by the back-end system 310 into recognized keywords. Thus, the user may enter the search query in the form of keywords, expressions, IP addresses, “human-friendly” terms, or a combination thereof. The search interface 315 may also provide other features in the search box 325. For example, in some embodiments, the search box 325 may have an auto-complete feature, such that as the user is inputting (e.g., typing) the search query, the search interface suggests options to complete the query. The search box 325 may also suggest synonyms, alternate terms, and/or keywords that the user may use as part of the search query. Additional features of the search query are described in U.S. application Ser. No. 15/143,060, filed on Apr. 29, 2016, the entirety of which is incorporated by reference herein. Thus, the search interface 315 is configured to receive a search query in a variety of forms.

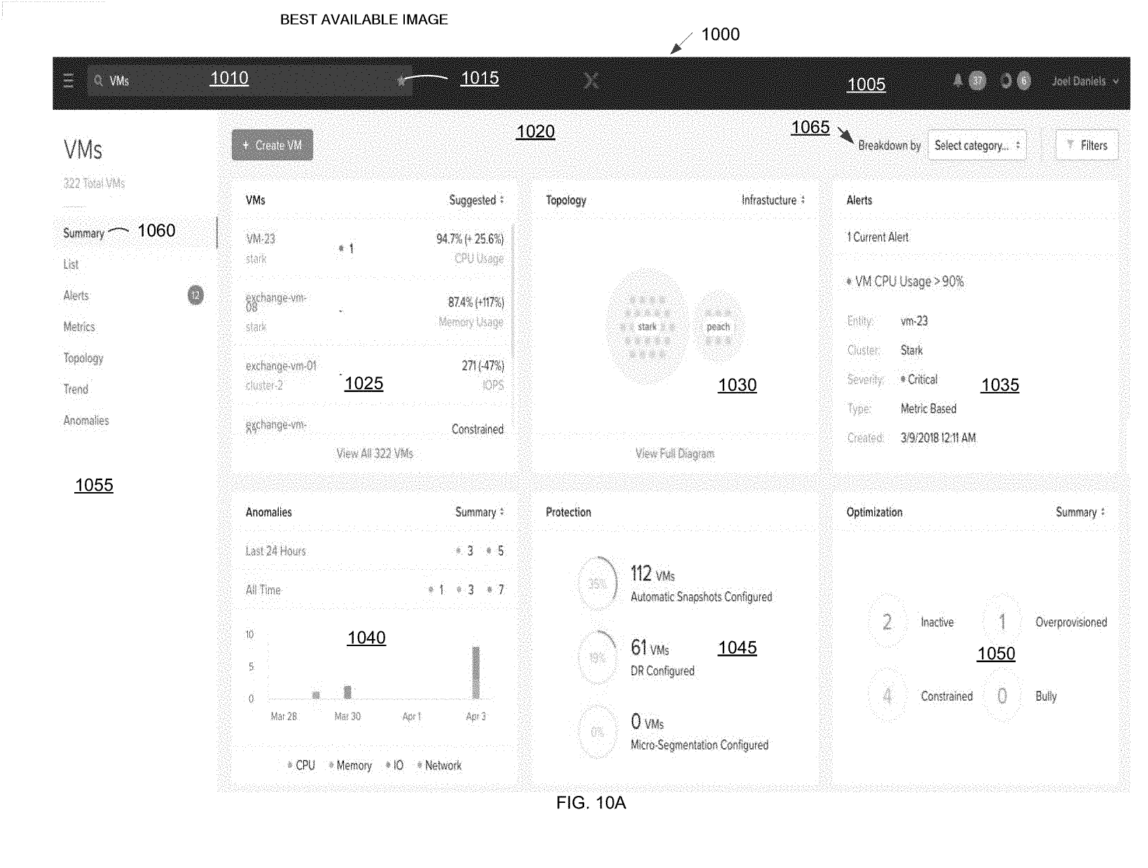

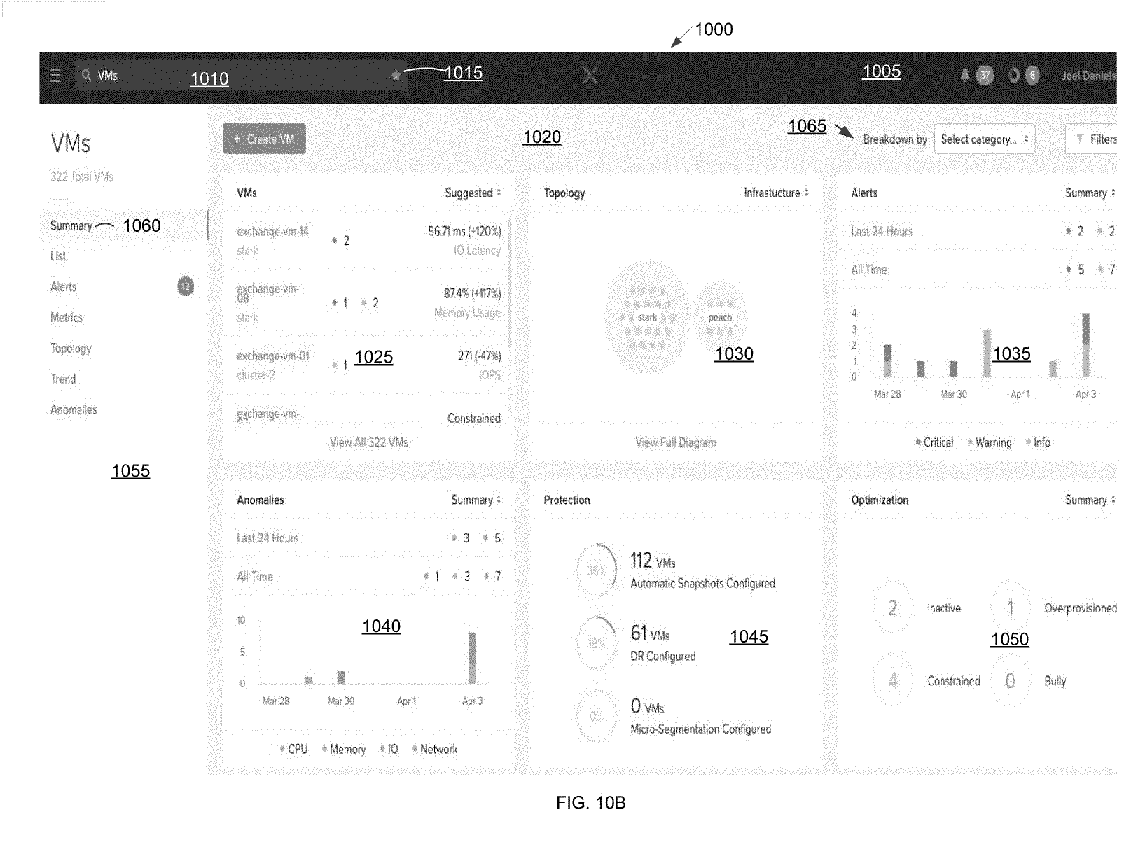

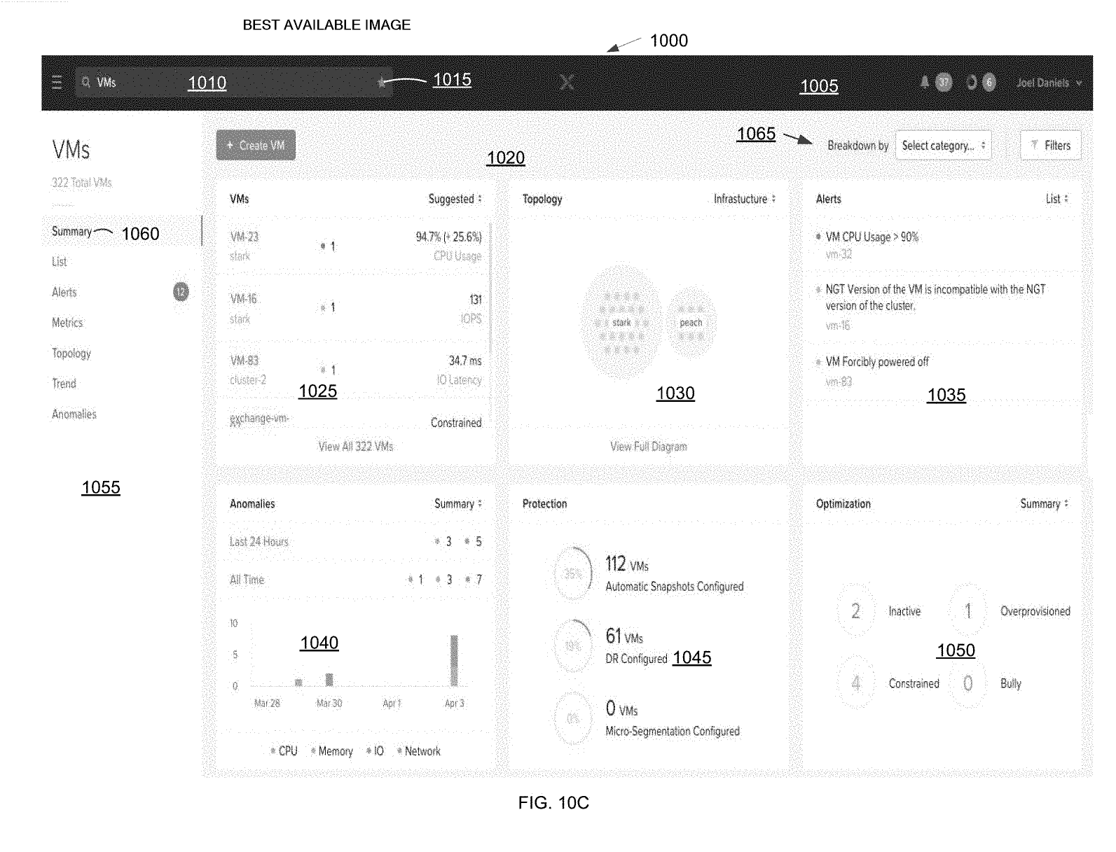

The search results that are retrieved in response to the search query input via the search interface 315 are displayed within the display interface 320. In some embodiments, the display interface 320 may include one or more widgets, such as widgets 335A, 335B, 335C, 335D, 335E, and 335F (collectively referred to herein as “widgets 335”). Each of the widgets 335 may be a particular type of widget that is configured to convey a particular type of information. For example, in some embodiments, one of the widgets 335 may be configured to display search results pertaining to alerts (e.g., notifications issued by components to indicate a problem). Another one of the widgets 335 may be configured to display search results pertaining to metrics, and so on. Thus, in some embodiments, the widgets 335 may be configured to categorize (e.g., sort) and display search results. In other embodiments, the widgets 335 may be configured to provide other type of information to the user. Example screenshots of the search console 305 showing the widgets 335 displaying the search results are shown in FIGS. 10A-10C below.

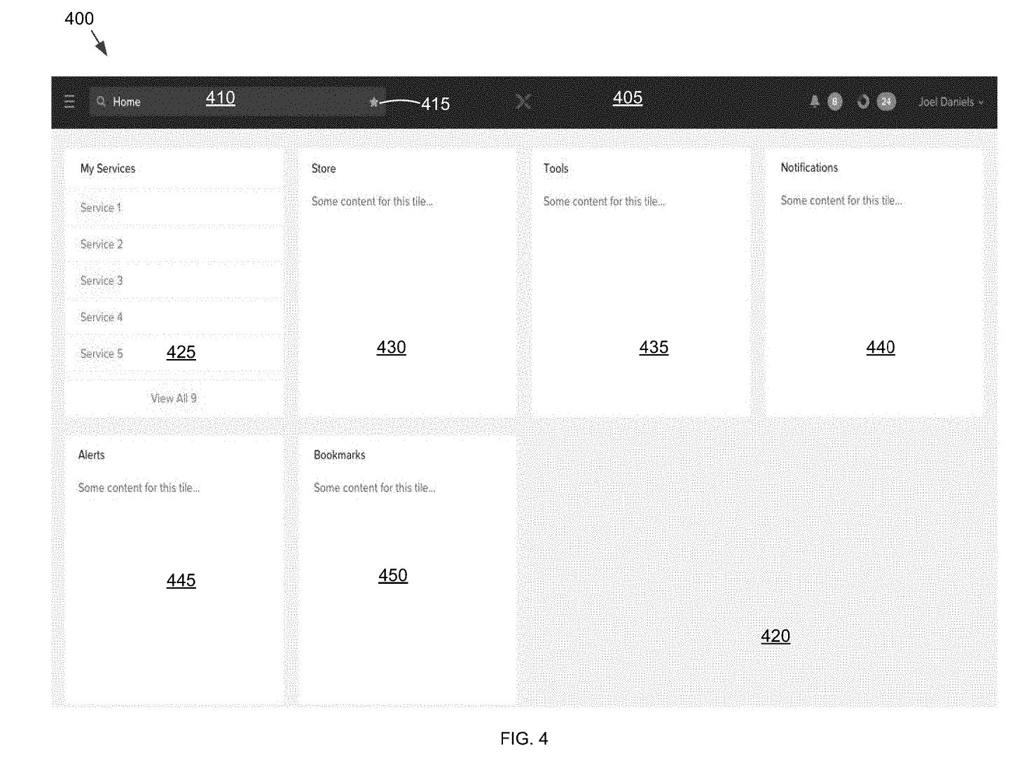

Further, in some embodiments, the widgets 335 that are displayed on the display interface 320 may vary based upon whether the display interface 320 is displaying the search results (e.g., in response to a search query entered into the search interface 315) or whether the display interface is on a “home screen.” The “home screen” may be the interface that is displayed upon launching or accessing the search system 300. In some embodiments, the search system 300 may be “launched” or “accessed” by interacting with (e.g., clicking on) a search system icon. In other embodiments, the search system 300 may be “launched” or “accessed” using other mechanisms. The “home screen” may also be reached by clicking on a designated button on the search console. An example screenshot of the search console 305 showing the display interface 320 on a “home screen” is shown in FIG. 4.

Turning to FIG. 4 and referring to FIG. 4 in conjunction with FIG. 3, an example screenshot of a search console 400 is shown, in accordance with some embodiments of the present disclosure. The search console 400 includes a search interface 405 having a search box 410 and a search button 415 using which a user may enter and send search queries for retrieving search results. The search console 400 also includes a display interface 420 that is on a “home screen.” The “home screen” of the display interface 420 includes widgets 425, 430, 435, 440, 445, and 450. Each of the widgets 425-450 may be configured for a different purpose and may display different information. For example, the widget 425 is configured to display at least a partial list of services that are currently installed on the virtual computing system (e.g., the virtual computing system 100) and associated with the search system 300. As will be explained below, once a service is installed and associated with the search system 300, that service becomes searchable using the search interface 405. Without being associated with the search system 300, a service is not searchable even if that service is installed within the virtual computing system. Thus, a service needs to be both installed and associated with the search system 300 to become searchable. The widget 425 shows the services that are both installed and associated with the search system 300.

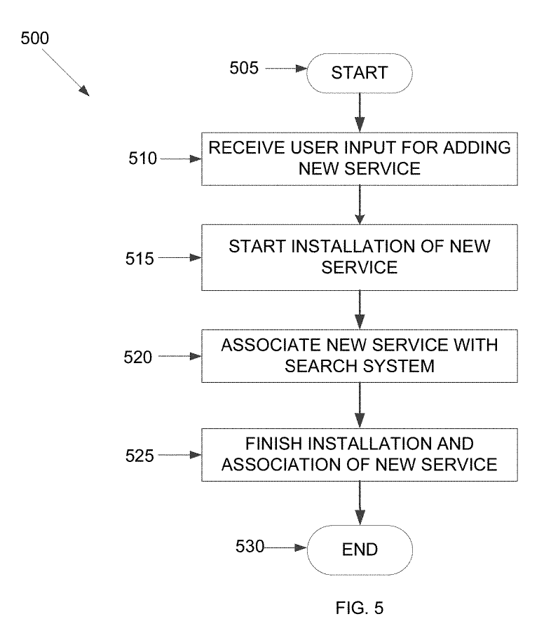

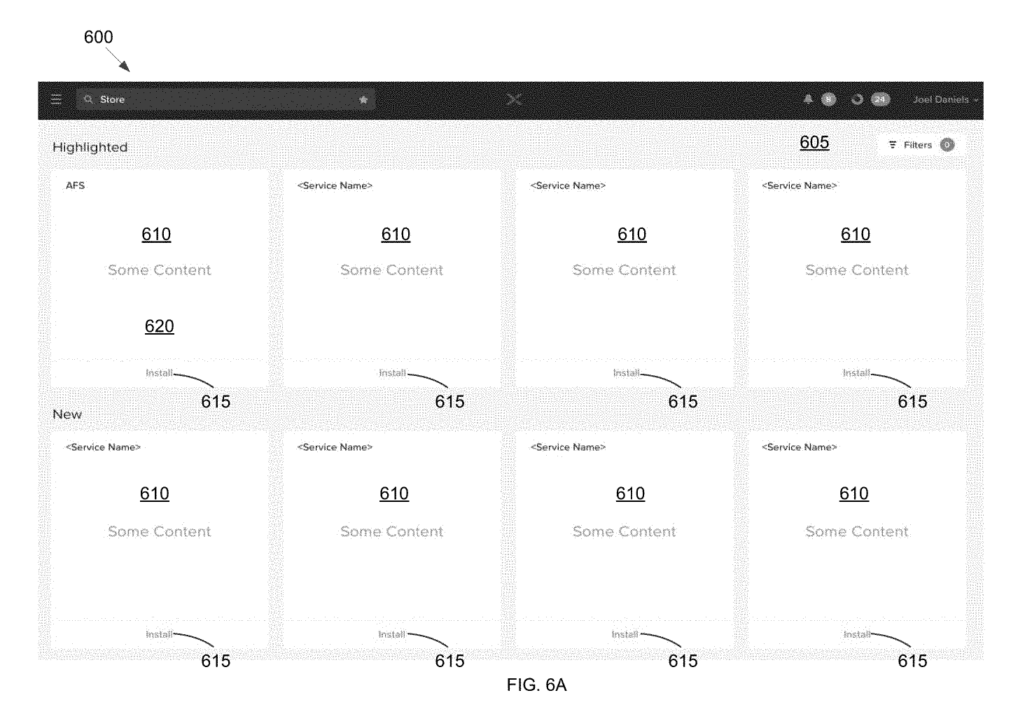

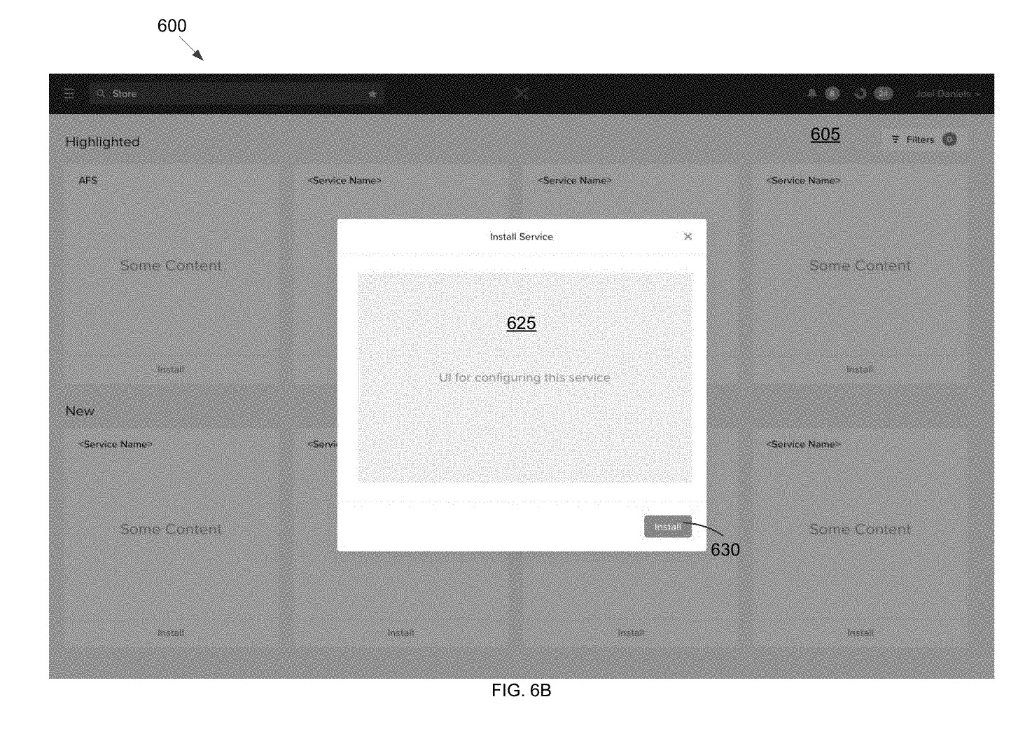

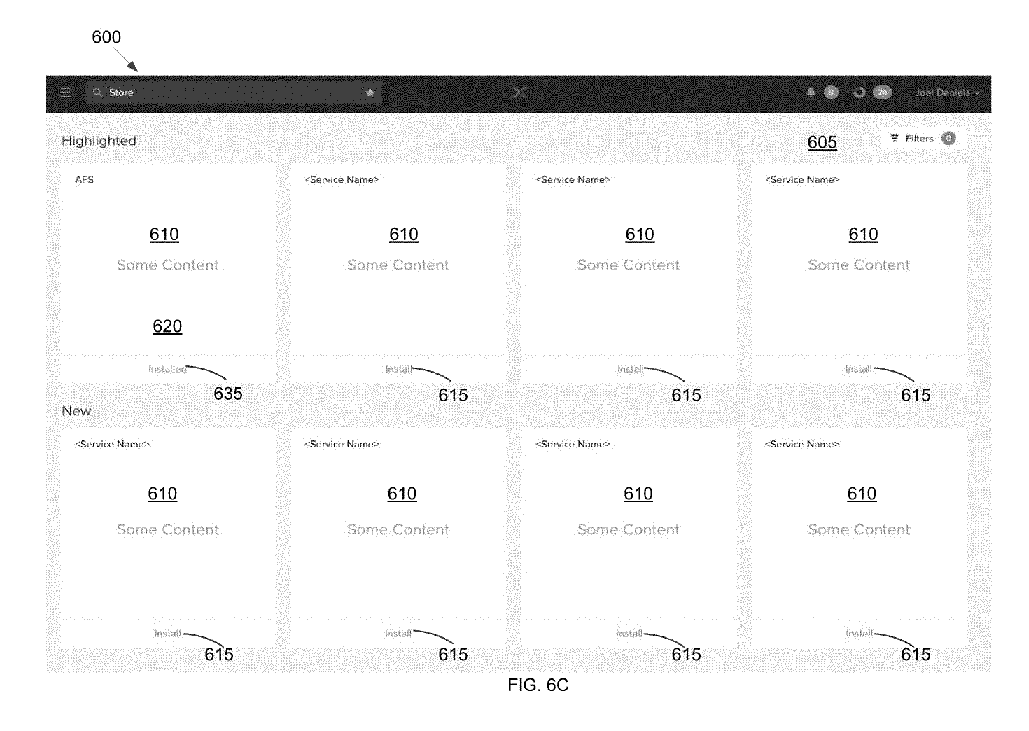

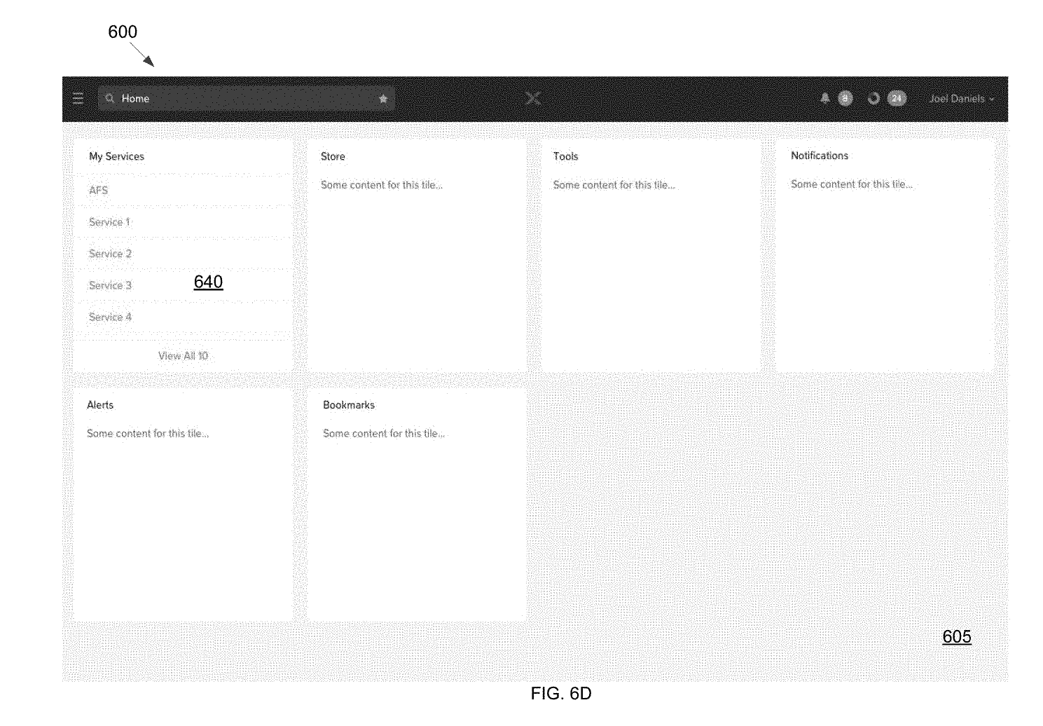

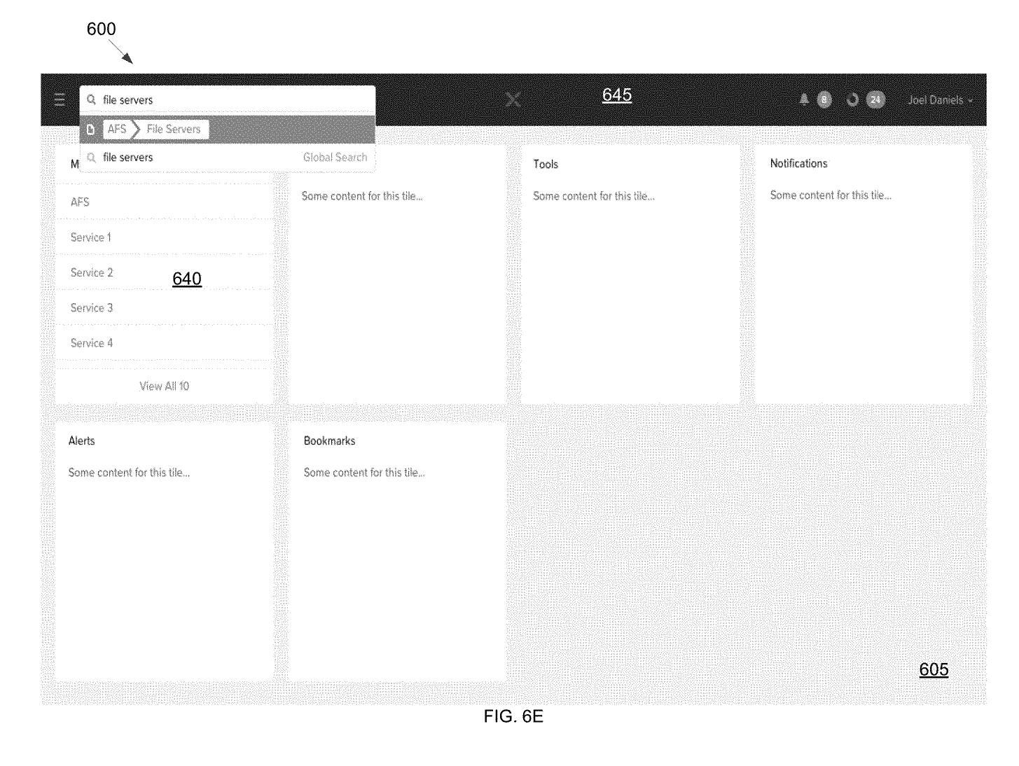

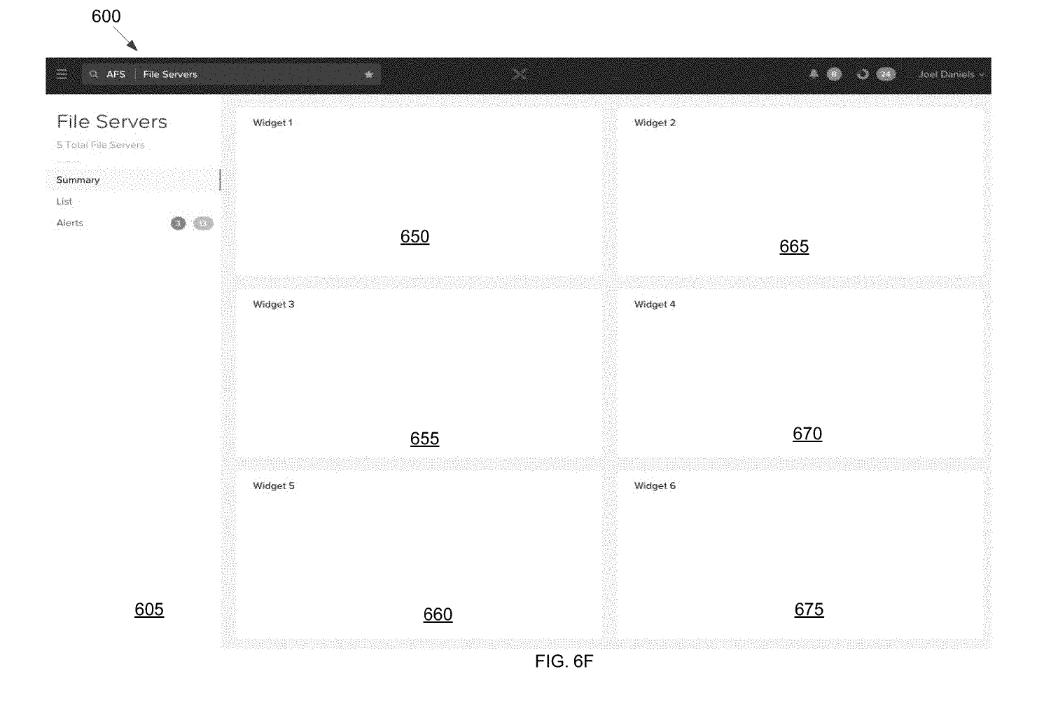

Further, in some embodiments, each of the services listed within the widget 425 may be interactive such that a user may click on one of those services to get more information about those services. It is to be understood that the number of services shown in the widget 425 and how those services are identified within the widget may vary in other embodiments. If there are no services that are installed and associated with the search system 300, the widget 425 may be empty. Similarly, the widget 430 may include a list of all services that are available but not yet installed and associated with the search system. Through the widget 430, a user may view, install, and associate services with the search system 300, as explained in greater detail below with respect to FIGS. 5-6F. The widget 435 may provide various tools and settings for customizing the search console 400 (e.g., adding and deleting the widgets to be displayed on the display interface 420, etc.), the widget 440 and the widget 445 may display any notifications and alerts that the search system 300 may be generating, and the widget 450 may include information that the user may have saved for future reference.

Notwithstanding the number and type of the widgets 425-450, in other embodiments, the number and type of widgets that are displayed within the display interface 420 may vary. Similarly, it is to be understood that the screenshot of the search console 400 is simply an example and is not intended to be limiting in any way. The configuration (e.g., shape, size, placement, orientation, organization of information, content of information, etc.) of the search interface 405 and the display interface 420, including the configuration of the widgets 425-450 and the other features of the search interface and the display interface may vary from one embodiment to another.

Returning back to FIG. 3, it is to be understood that although six widgets (e.g., the widgets 335) are shown herein, the number of widgets that are shown in the display interface 320 in other embodiments may vary. Further, the shape, size, arrangement, and other configuration of the widgets 335 may vary in other embodiments. Additionally, although only the widgets 335 are shown in the display interface 320, in other embodiments, additional information such as navigational menus, filters, adjustment options, etc. that may be considered useful or desirable to include in the search system 300, may be displayed within the display interface 320. Further, in some embodiments, one or more of the widgets 335 may or may not be interactive. If interactive, the user may interact with (e.g., click) a particular item within the interactive widget (e.g., the widgets 335) to view/access additional information related to that item.

Likewise, the various features of the search console 305 discussed above are simply examples and not intended to be limiting in any way. The placement, design, configuration, and the various features that are made available to the user via the search console 305 may vary from one embodiment to another. Further, only certain features of the search console 305 are shown herein. Nevertheless, in other embodiments, other features that are commonly provided on user interfaces and particularly, on user interfaces used in a virtualization environment (e.g., the virtual computing system 100) may be provided.

Referring still to FIG. 3, the back-end system 310 is configured to receive the search queries via the search console 305, analyze the search queries, and return search results on the display interface 320 in response to those search queries. Although not shown, the back-end system 310 may be configured as hardware, software, firmware, or a combination thereof. Specifically, the back-end system 310 may include one or more processing units configured to execute instructions and one or more memory units to store those instructions and other conversion related data. In some embodiments, the back-end system 310 may be connected to a storage pool (e.g., the storage pool 170) to receive, send, and process information, and to control the interactions with the users. The instructions may be carried out by a special purpose computer, logic circuits, or hardware circuits of the back-end system 310. The processing units may, thus, be implemented in hardware, firmware, software, or any combination thereof. The processing units execute an instruction, meaning that they perform the operations called for by that instruction. The processing units may retrieve a set of instructions from a memory (e.g., the storage pool 170 or any other memory in which such instructions may be stored). For example, in some embodiments, the processing units may retrieve the instructions from a permanent memory device like a read only memory (ROM) device and copy the instructions in an executable form to a temporary memory device that is generally some form of random access memory (RAM). The ROM and RAM may both be part of the storage pool (e.g., the storage pool 170), or in some embodiments, may be separately provisioned from the storage pool. Further, the processing units may include a single stand-alone processing unit, or a plurality of processing units that use the same or different processing technology. The instructions may be written using one or more programming language, scripting language, assembly language, etc.

The back-end system 310 includes (or is associated with) a search manager 340 that is configured to receive the search queries from the search interface 315, manage the retrieval of search results, and cause the search results to be displayed on the display interface 320. In some embodiments, the search manager 340 is in communication with a query parser 345, a search results system 350, a content mapping system 355, a service registration system 360, and a database 365 to facilitate the retrieval of the search results. In other embodiments, the search manager 340 may be associated with or otherwise communicate with additional components within the virtual computing system (e.g., the virtual computing system 100) to retrieve the search results. In some embodiments, the search manager 340 may be omitted and the individual components (e.g., the query parser 345, the search results system 350, the content mapping system 355, and the service registration system 360) of the back-end system 310 may collaborate with one another to receive the search queries from the search interface 315, manage the retrieval of search results, and cause the search results to be displayed on the display interface 320.

It is to be understood that although the search manager 340, the query parser 345, the search results system 350, the content mapping system 355, the service registration system 360, and the database 365 are the only components shown in the back-end system 310, in other embodiments, other components that are needed or desired to perform the functions described herein may be provided within the back-end system. Further, although the search manager 340, the query parser 345, the search results system 350, the content mapping system 355, the service registration system 360, and the database 365 have been shown as separate components, in some embodiments, one or more of those components may be combined together such that the combined component is configured to perform the operations of the individual components that are combined.

Thus, when a user enters a search query in the search box 325 of the search interface 315 and interacts with the search button 330, the search query entered into the search box is sent to the search manager 340 of the back-end system 310. The search manager 340 transfers the search query to the query parser 345, which parses the search query and converts the parsed search query into a structured query to facilitate retrieval of search results. To parse the search query and convert the search query into a structured query, the query parser 345 includes a tokenizer 370, a keyword block 375, an expression block 380, and an IP address block 385. The keyword block 375 is a database that stores a list of all keywords that are recognized by the search system 300. Similarly, the expression block 380 is a database that stores a list of all recognized expressions, while the IP address block 385 is a database that stores a list of all recognized IP addresses. Although shown as separate components, in other embodiments, one or more of the keyword block 375, the expression block 380, and the IP address block 385 may be combined together. Further, one or more of the keyword block 375, the expression block 380, and the IP address block 385 may be stored within the database 365 that is associated with or is provisioned from the storage pool 170. In other embodiments, one or more of the keyword block 375, the expression block 380, and the IP address block 385 may be part of a database that is separate from the database 365 and the storage pool 170 but is accessible by the search system 300.

Also, in some embodiments, the query parser 345 may include a correlation block (not shown) for converting any “human-friendly” words in the search query into recognized keywords, expressions, and/or IP addresses. In some embodiments, the correlation block may be part of one or more of the keyword block 375, the expression block 380, and/or the IP address block 385.

The query parser 345 receives the search query directly from the search interface 315 or from the search manager 340 and converts that query into a structured query using the tokenizer 370. The tokenizer 370 of the query parser 345 breaks or tokenizes the search query and particularly, the characters of the search query, into a plurality of tokens. For each token, the tokenizer 370 parses that token into recognized keywords, expressions, and/or IP addresses. The tokenizer 370 may communicate with the keyword block 375, the expression block 380, and the IP address block 385 to parse the search query. The tokenizer 370 may also convert any “human-friendly” terms in the search query into recognized keywords. Further, although not shown, in some embodiments, the tokenizer 370 may also include or be in communication with additional components such as a ranking block to rank the identified keywords, a relationship block to identify relationships between the keywords, a matching block to match keywords and assign scores, etc. to facilitate conversion of the search query into the structured query.

Simply as an example and without intending to be limiting in any way, if the search query input by the user is “V1 latency,” the tokenizer 370 may first tokenize the search query into two tokens, for example, a first token “V1” and a second token “latency.” For the first token, “V1,” the tokenizer 370 may reference one or more of the keyword block 375, the expression block 380, the IP address block 385, and any other information that the tokenizer has access to, and determine that the first token is likely an identifier (e.g., name) associated with a particular entity and/or entity type. Specifically, the tokenizer 370 may find references (e.g., by word matching and/or other mechanism) of “V1” within the keyword block 375, the expression block 380, the IP address block 385, etc. to identify all components that have “V1” as part of a keyword. For example, the tokenizer 370 may find that “V1” appears in the names of a specific cluster, a specific virtual machine, and a specific virtual disk. The tokenizer 370 may associate the cluster, virtual machine, and virtual disk that have “V1” in their names with the first token. Thus, the tokenizer 370 has identified one or more entities and/or entity types for the first token.

Along with parsing the first token or after parsing the first token, the tokenizer 370 may parse the second token, “latency” in the search query “V1 latency.” Again, the tokenizer 370 may access the keyword block 375, the expression block 380, the IP address block 265, etc. to find (e.g., by word matching and/or other mechanism) references to “latency.” The tokenizer 370 may determine that “latency” is a keyword associated with a metric.

Thus, based upon the information obtained by the tokenizer 370, the tokenizer parses the search query and converts the search query into a structured query, which identifies one or more entity types and/or one or more entities from the search query, as well as one or more keywords associated with a property, action, and/or other activity (e.g., alerts). If the search query is not indicative of an entity type and/or a particular entity, the tokenizer 370 may designate a default entity type and/or entity. Similarly, if the search query is not indicative of a property, action, and/or other activity, the tokenizer 370 may designate a default property, action, and/or other activity.

Thus, the query parser 345 receives a search query and converts the search query into a structured query. The structured query provides a framework for retrieving the search results. Each structured query may also be stored within the database 365 (or in another database) for future usage and reference. Additional details for parsing the search query and converting the search query into a structured query are provided in U.S. application Ser. No. 15/143,060, filed on Apr. 29, 2016, the entirety of which is incorporated by reference herein. The query parser 345 may also provide the structured query to the search manager 340, the search results system 350, and/or the content mapping system 355 for retrieval and display of the search results.

Therefore, the search results system 350 receives the structured query either directly from the query parser 345 or from the search manager 340. The search results system 350 retrieves and compiles the search results corresponding to the structured query. The search results system 350 may be configured to access the storage pool 170, as well as any other database accessible to the search system 300 to gather data corresponding to the structured query. For example, for the structured query obtained from the search query “V1 latency,” the search results system 350 may retrieve latency related data from the entity (and/or entity type) “V1.” The search results system 350 may also aggregate, sort, and rank the search results and return those results to the search manager 340 and/or to the content mapping system 355. The search results system 350 (and/or the search manager 340) may also cause the search results to be stored within the database 365 (or another database) for access and use later.

Thus, the content mapping system 355 receives the search results either directly from the search results system 350 or from the search manager 340. The content mapping system 355 may also receive the structured query (or portions thereof) from the query parser 345 and/or the search manager 340. The content mapping system 355 may additionally receive any other information that may be considered necessary or desirable for the content mapping system to have in performing the operations thereof. The content mapping system 355 determines how to display the search results within the display interface 320. For example, the content mapping system 355 determines which ones of the widgets 335 to show within the display interface 320 based upon the search results. The content mapping system 355 also determines the manner in which the search results are displayed within the widgets 335 that are to be shown within the display interface 320. Thus, the content mapping system 355 determines a “view” of the search results to be shown within the widgets 335. For example, the content mapping system 355 may determine whether to display the content in a detailed view, a list view, or a visual view. The content mapping system 355 is explained in greater detail below.

Upon identifying the widgets 335 to display within the display interface 320 and the manner of displaying the search results within those widgets, the content mapping system 355 may provide an indication to the search manager 340 and/or directly cause the widgets to be displayed within the display interface 320. The indication to the search manager 340 may include an identification of the widgets to be displayed along with the “view” in which the search results are to be displayed within those widgets. In other embodiments, the indication may include additional or other information that is considered necessary or desirable to provide to the search manager 340 to cause the search results to be accurately and appropriately displayed within the display interface 320.

Referring still to FIG. 3, the back-end system 310 also includes the service registration system 360. The service registration system 360 is configured to install (also referred to herein as “deploy”) within the virtual computing system (e.g., virtual computing system 100) and associate those new services with the search system 300 to make those new services automatically searchable. Conventionally, to make a newly installed service searchable, the user has to manually integrate (e.g., associate) the service with the search system 300. As part of the manual integration, the user first has to identify various keywords, expressions, and/or IP addresses that are considered necessary or desirable to be searchable and then possibly reprogram the service to include the searchable keywords, expressions, and/or IP addresses therein. Additionally, the user has to manually update the various databases (e.g., the keyword block 375, the expression block 380, and the IP address block 385) with the keywords, expressions, and/or IP addresses such that the tokenizer 370 has access to those keywords, expressions, and/or IP addresses in parsing a search query related to the service, as well as update the search results system 350 such that the search results system knows where to access data related to the service in gathering the search results. Thus, making a newly added service searchable is not only complicated, it is time consuming and prone to errors.

The service registration system 360 simplifies the above process by making those services searchable upon installation and automatic association with the search system 300. Thus, the service registration system 360 is configured to dynamically expand the search system 300. The service registration system 360 is discussed in greater detail below. Also, as used herein, a “service” is a software application, a software file, a hardware component, or any other hardware, software, and/or firmware entity as discussed above that is added to the virtual computing system (e.g., the virtual computing system 100) after the installation and activation of the search system 300.

Turning now to FIG. 5, an example flow chart outlining operations of a process 500 for installing and integrating a new service with a search system (e.g., the search system 300) is shown, in accordance with some embodiments of the present disclosure. The process 500 may include additional, fewer, or different operations, depending on the particular embodiment. The process 500 is discussed in conjunction with FIGS. 3, 4, and 6A-6F. FIGS. 6A-6F are example screenshots showing the installation and integration of a new service with the search system 300. The process 500 is implemented by the service registration system 360. The process 500 starts at operation 505 with the user deciding to install and associate a new service with the search system 300.

To install and associate a new service with the search system 300, the user may access the “home screen” of the display interface 420. From the “home screen,” the user may access the new service to be installed and integrated via the service store of the widget 430. For example, the user may interact with (e.g., click on) the widget 430 to access the available services, shown in FIG. 6A. Specifically, FIG. 6A is an example screenshot of a search console 600 showing a display interface 605 that is accessed via the widget 430. The display interface 605 provides a listing of all or a subset of services 610, as part of the service store, that are available to the user for installing and associating with the search system 300. The user may interact with one of the services from the service store to begin the installation and association process. For example, the user may interact with (e.g., click on) an install button 615 within widget 620 to install the service (“AFS” as shown in FIG. 6A) associated with that widget. Upon interacting with the install button 615, an indication is sent to the service registration system 360 directly or via the search manager 340 at operation 505 to start the installation and association process.

At operation 515, the service registration system 360 starts installing the selected service (e.g., AFS) within the virtual computing system (e.g., the virtual computing system 100). For example, in some embodiments, upon receiving the indication to install and associate the selected service, the service registration system 360 may present an installation service dialog box 625 to the user, shown in FIG. 6B. Although not shown, the installation service dialog box 625 may present/request information pertaining to the installation. For example, the installation service dialog box 625 may ask if the user wants to rename the service. The installation service dialog box 625 may also ask the user for the location where the service is to be installed. For example, in some embodiments, the user may choose to install the service on a hardware component (e.g., one of the user VMs 120) within the virtual computing system (e.g., the virtual computing system 100) or on the cloud that is associated with the virtual computing system. Similarly, the installation service dialog box 625 may present/request other information to install the selected service. Upon providing the information requested in the installation service dialog box 625, the user may interact with (e.g., click on) an install button 630 to start the installation process.

The service registration system 360 may receive an indication when the user interacts with the install button 630. As part of the installation of the service or after the installation of the service, the service registration system 360 starts registering the service with the search system 300 at operation 520 to associate the service with the search system. For registering the service with the search system 300, the service registration system 360 identifies the various searchable aspects of the service. In some embodiments, the aspects of the service that are searchable and the keywords associated with those searchable aspects may be pre-programmed within the service and the service registration system 360 may be configured to access those keywords. In other embodiments, other mechanisms may be used by the service registration system 360 to identify the searchable aspects of the service. Upon identifying the searchable aspects and the keywords associated with those searchable aspects, the service registration system 360 adds those keywords to the keyword block 375 of the query parser 345. The service registration system 360 may additionally update the search results system 350 or associate the service with the search result system such that the search results system is able to access the service in gathering data for the search results when a structured query includes keywords that are associated with the service. The service registration system 360 may perform other actions as well that may be needed or considered desirable to integrate the service with the search system 300 and particularly the query parser 345 and the search results system 350.

Upon completion of the installation and registration of the service, the service registration system 360 may send an indication to the user at operation 520. In some embodiments, the service registration system 360 may display a notification on the search console 600. Alternatively, in some embodiments and as shown in FIG. 6C, once installation and integration is complete, the service registration system 360 may cause the installation service dialog box 625 to disappear and replace the install button 615 within the widget 620 with a notification (e.g., “installed”) 635. Additionally, the service registration system 360 may cause the installed and registered service to be added to the list of services in a widget 640 of the “home screen,” as shown in FIG. 6D. The widget 640 is analogous to the widget 425 of FIG. 4. Further, in some embodiments, upon installing and registering the service with the search system 300, the service may be removed from the service store. The process 500 ends at operation 530.

Upon installing and registering the service with the search system 300, the service may be searched and all search features may be available for searching that service. For example and as shown in FIG. 6E, the newly added service may be searched simply by inputting a search query in a search interface 645 of the search console 600. Since the service is registered with the search system 300, the query parser 345 is able to recognize the keywords from the search query (or convert the search query into recognizable keywords) and associate those keywords with the newly added service. The search results system 350 is also able to retrieve search results pertaining to the service and the content mapping system 355 is able to display the search results in one or more widgets (e.g., widgets 650, 655, 660, 665, 670, and 675), as shown in FIG. 6F.

Thus, the search system 300 and particularly the service registration system 360 provides an easy, automatic, and convenient mechanism to add new services and associate those services with the search system for searching. Therefore, the search system 300 is dynamic and adapts as services are added (or removed) from the virtual computing system (e.g., the virtual computing system 100).

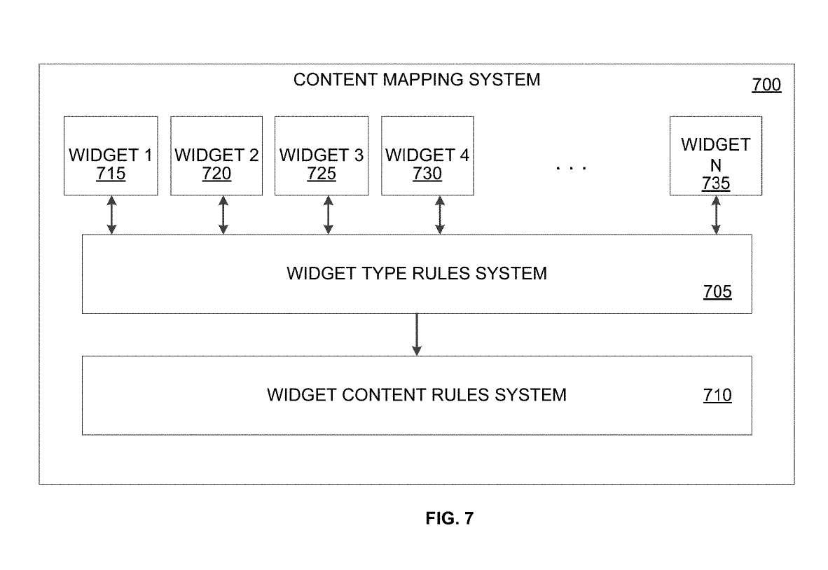

Turning now to FIG. 7, an example block diagram of a content mapping system 700 is shown, in accordance with some embodiments of the present disclosure. The content mapping system 700 is analogous to the content mapping system 355 of FIG. 3 above. The content mapping system 700 is configured to determine a subset of widgets (e.g., the widgets 335) to display on the display interface (e.g., the display interface 320), as well as determine the manner of displaying the search results within the displayed widgets. Thus, the content mapping system 700 includes a widget type rules system 705 that determines the subset of widgets to be displayed and a widget content rules system 710 that decides the manner of displaying the search results within the displayed widgets. Although the widget type rules system 705 and the widget content rules system 710 are shown as separate components herein, in other embodiments, the widget type rules system and the widget content rules system may be integrated together. Further, although only the widget type rules system 705 and the widget content rules system 710 are shown in the content mapping system 700, in other embodiments, other components that may be needed or considered desirable to perform the functions described herein may be provided.

The widget type rules system 705 is in communication with a plurality of widgets (e.g., widgets 715, 720, 725, 730, and 735). Although the widgets 715-735 have been shown as being part of the content mapping system 700, in other embodiments, those widgets may be part of another component associated with the search system (e.g., the search system 300) and communicably connected to the content mapping system, and particularly, the widget type rules system 705. In some embodiments, each of the widgets 715-735 may be pre-defined to be of a particular type. For example, in some embodiments, one of the widgets 715-735 may be an alerts widget that is configured to display alert related information in the display interface (e.g., the display interface 320). Another type of widget may be a metric widget that is configured to display metric related information in the display interface. Yet another type of widget may be a topology widget that is configured to display spatial relationships between components, and so on. Thus, the widgets 715-735 may be of a variety of types. In other embodiments, the widgets 715-735 need not be pre-defined. Rather, the widgets 715-735 may be empty shells and the content mapping system 700 may be configured to dynamically define the type of each of the widgets based upon the search results and any other factor considered essential or desirable. In yet other embodiments, the widgets 715-735 may be a combination of pre-defined and dynamically defined.

It is to be understood that the term “widget” is not intended to be limiting in any way. A “widget” is intended to mean a software control element within a user interface (e.g., a graphical user interface) that enables a user to view information, perform a function, and/or access more information. Thus, a widget may be interactive or non-interactive. Some widgets may include both interactive and non-interactive features. When interactive, a widget may be configured to facilitate a specific type of user-computer interaction. Widgets may include buttons, check boxes, containers, labels, scroll bars, menu bars, toolbars, ribbons, graphs, windows, and a variety of other features that may be considered necessary or desirable to accurately and appropriately display the search results. Further, the shape, size, orientation, and other design related features of a widget may also vary from one embodiment to another. Thus, each of the widgets 715-735 may be configured in a variety of ways and each widget may be configured differently from the other widgets.

Each of the widgets 715-735 may be configured to be activated when certain conditions are satisfied. These conditions may be stored as rules within the widget type rules system 705. Based on the satisfaction of one or more of those conditions, the widget type rules system 705 may activate or de-activate one or more of the widgets 715-735. The conditions that cause the widget type rules system 705 to activate and de-activate the widgets 715-735 may be pre-determined and pre-programmed within the widget type rules system. Further, the widget type rules system 705 may receive the search results from the search manager (e.g., the search manager 340) and/or the search results system (e.g., the search results system 350), the structured query from the search manager and/or the query parser (e.g., the query parser 345), and/or any other information that is considered essential or desirable to have for the widget type rules system in deciding which of the widgets 715-735 to activate based on the conditions.

One such condition may be related to entity type. Each of the widgets 715-735 may be associated with one or more entity types, such that when search results pertaining to those entity types are retrieved, the widget type rules system 705 activates only those widgets that are associated with those entity types. The widgets 715-735 that are not associated with that entity type are deactivated. Another condition may pertain to the current state of the system (e.g., the current state of the virtual computing system 100). The content mapping system 700, and particularly, the widget type rules system 705 may receive or be configured to access information that may convey the current state of the system. Based on the current state of the system, the widget type rules system 705 may decide which of the widgets 715-735 to activate. For example, if the current state of the system reveals that several virtual machines are running slow, the widget type rules system 705 may activate the widgets 715-735 that are associated with virtual machines for displaying virtual machine related information in the display interface (e.g., the display interface 320) and facilitating identification and resolution of the cause of slowness in the virtual machines. Likewise and continuing with the virtual machine slowness example above, the widget type rules system 705 may be in communication with a troubleshooting system within the virtual computing system (e.g., the virtual computing system 100) that may have identified the cause of slowness in the virtual machines. The widget type rules system 705 may receive such information from the troubleshooting system and activate the widgets 715-735 that are configured to display the information associated with the cause of the slowness.

Yet another condition may be based on a number of results of a particular type within the search results. For example, if the widget type rules system 705 determines that the search results contain a large number of alerts (e.g., based on a number of alerts exceeding a pre-determined threshold), the widget type rules system may activate the widget that is associated with displaying alert related information. Thus, the widget type rules system 705 may be configured with a variety of conditions or rules based on which, the widget type rules system either activates or de-activates the widgets 715-735.

It is to be understood that only some conditions are discussed above. Nevertheless, in other embodiments, additional, fewer, or different conditions may be programmed within the widget type rules system 705 for activating and de-activating the widgets 715-735. In addition to determining the subset of the widgets 715-735 to activate, the widget type rules system 705 may also be configured to determine, in some embodiments, a number of the widgets to be displayed in the display interface (e.g., the display interface 320). For example, in some embodiments, the widget type rules system 705 may be configured to display no more than a maximum number of widgets. If the widget type rules system 705 has identified a number of widgets to activate that is greater than the maximum number, the widget type rules system may be programmed with a second set of conditions to further short-list that number of widgets until a number of widgets to be activated is less than or equal to the maximum number.

In other embodiments, the widget type rules system 705 may not be configured with a maximum number of widgets to display. Rather, the widget type rules system 705 may be configured to display all of the widgets that the widget type rules system has identified for activation and/or display at least a minimum number of widgets. Thus, the widget type rules system 705 may be programmed in a variety of ways to identify which ones of the widgets 715-735 to activate.

Referring still to FIG. 7, upon determining the subset of the widgets 715-735 to activate, the widget content rules system 710 determines the manner of displaying the search results within each of those widgets. Thus, the widget content rules system 710 receives a list (or some other indication) of the type of the subset of widgets that are to be activated, as well as receives the search results (and any other information considered desirable). In some embodiments, the widget content rules system 710 may sort the search results (or another component such as the widget type rules system 705, search results system 350, etc. may sort the search results and provide the sorted search results to the widget content rules system). Through sorting, the widget content rules system 710 may determine a number of search results of a particular type. For example, the widget content rules system 710 may sort through the results to determine that the search results contain “X” number of alert related search results, “Y” number of metric related search results, etc.

By determining the number of search results of a particular type, the widget content rules system 710 may tailor the manner in which the search results are displayed within the widgets 715-735 that are to be activated and displayed within the display interface (e.g., the display interface 320). For example, in some embodiments, the widget content rules system 710 may tailor a “view” of the search results to be displayed within each of the widgets 715-735 that are to be activated. Specifically, if the widget content rules system 710 determines that the search results contain a large number of search results of a particular type, the widget content rules system may determine that the best way to convey those large number of search results is via a visual or pictorial view, such as a graph, chart, etc. If the widget content rules system 710 determines that the search results contain a single search result of a particular type, the widget content rules system may determine that a detailed view of the search result may be provided. Likewise, if the widget content rules system 710 determines that the search results contain a small number of search results of a particular type (e.g., greater than a single search result but less than a large number of search results), the widget content rules system may determine that the best way to convey those search results may be via a listing of the search results.

Therefore, based upon the number of search results of a particular type, the widget content rules system 710 may decide whether to show overview or detailed information about the search results of a particular type. The widget content rules system 710 may tailor each widget individually based upon the type of search results. Thus, one widget may have a list view, another widget may have a detailed view, and yet another widget may have a graphical view, and so on. What constitutes a “small number” and a “large number” of search results may be pre-defined and pre-programmed within the widget content rules system 710.

By deciding which widgets to display and the content of those widgets based upon a variety of conditions including the current state of the system, the size of the environment (e.g., the number of search results of a particular type), etc., the content mapping system 700 provides a dynamic search system (e.g., the search system 300). Further, the search results that are displayed and the manner in which the search results are displayed make it easier for the user to navigate through the search results and analyze complex information in a simple, streamlined way.

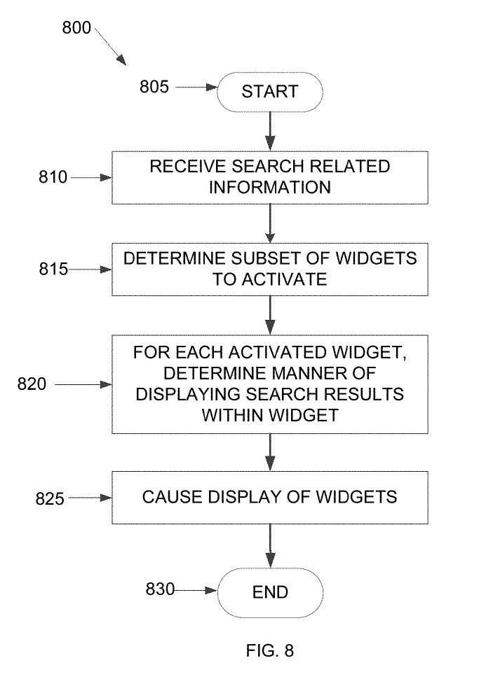

Turning now to FIG. 8, an example flow chart outlining operations of a process 800 for deciding how to present the search results within the display interface (e.g., the display interface 320) of the search system (e.g., the search system 300) is shown, in accordance with some embodiments of the present disclosure. The process 800 may include additional, fewer, or different operations, depending on the particular embodiment. The process 800 is discussed in conjunction with FIGS. 3 and 7. The process 800 is implemented by the content mapping system 700. The process 800 starts at operation 805 with a user entering a search query into the search interface 315 and sending the search query to the back-end system 310. As discussed above, the back-end system 310 parses the search query and converts the search query into a structured query and retrieves search results corresponding to the structured query.

At operation 810, the content mapping system 700, and particularly, the widget type rules system 705 of the content mapping system, receives the search results, the structured query, and any other search related information that may be deemed necessary or desirable for the widget type rules system to have. Based on the information received at the operation 810, the widget type rules system 705 determines, at operation 815, one or more widgets (e.g., the widgets 715-735) to activate. Specifically, as discussed above, the widget type rules system 705 may be programmed with a variety of conditions. The widget type rules system 705 may apply those conditions on the information received at the operation 810 to determine which of the widgets to activate at the operation 815. As indicated above, at least some of the conditions may be based upon entity type, current state of the system, and the types of search results (e.g., alerts, metrics, etc.). In other embodiments, additional, fewer, and/or different conditions may be used.

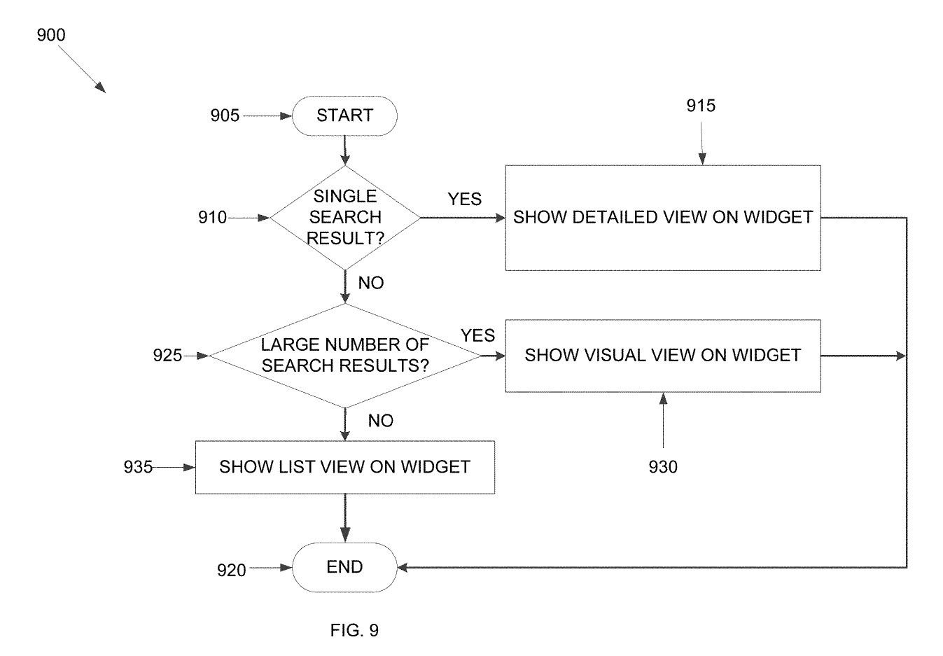

Upon identifying the widgets to be activated, at operation 820, the widget content rules system 710 of the content mapping system 700 decides the manner in which the search results are to be displayed within each of the widgets to be activated. Specifically, the widget content rules system 710 analyzes the search results to determine a number of search results of a particular type and based upon that number, the widget content rules system decides whether to display the search results in a visual view, in a list view, or a detailed view. The operation 820 is discussed in greater detail in FIG. 9 below. Thus, the content mapping system 700 determines the best way to present the search results to the user in a meaningful, organized, and systematic manner.

The widgets are displayed within the display interface at operation 825. Specifically, the content mapping system 700, and particularly, the widget content rules system 710 of the content mapping system provides an indication to the search manager 340 of the widgets to be presented on the display interface 320, the associated search results to be displayed within those widgets, and the manner of displaying those search results within the widgets. The search manager 340 may then cause those widgets to be displayed on the display interface 320. In those embodiments in which the search manager 340 is not provided, the widget content rules system 710 may directly cause the display of those widgets on the display interface 320. The process 800 ends at operation 830.

Referring now to FIG. 9, an example flow chart outlining operations of a process 900 for deciding a manner of displaying the search results within widgets is shown, in accordance with some embodiments of the present disclosure. The process 900 may include additional, fewer, or different operations, depending on the particular embodiment. The process 900 is discussed in conjunction with FIGS. 3 and 7. The process 900 is implemented by the content mapping system 700. The process 900 starts at operation 905 with the content mapping system 700, and particularly, the widget type rules system 705, deciding which widgets (e.g., the widgets 715-735) to activate. The widget content rules system 710 receives an indication from the widget type rules system 705 of the type of widgets that are to be activated and the widget content rules system then decides how to display the search results within the widgets to be activated. In some embodiments, the widget content rules system 710 may receive additional information to facilitate the determination of the manner of displaying the search results. The process 900 may be performed at the operation 820 of FIG. 8. Further, the process 900 may be performed for each widget that is to be activated, such that the manner in which the search results are displayed on one widget is independent of the manner in which the search results are displayed on another widget.

Additionally, the widget content rules system 710 may sort the results or use another mechanism to determine a number of search results of a particular type. In some embodiments, instead of determining the number of search results of a particular type itself, the widget content rules system 710 may receive such a determination from another component within the search system 300. By determining the number of search results of a particular type, the widget content rules system 710 adapts to the changing state of the virtual computing system (e.g., the virtual computing system 100). Specifically, by changing the manner in which the search results are presented to the user based upon a number of search results of a particular type, the widget content rules system 710 can accommodate the increasing size of the virtual computing system and still present the search results to the user in an organized and useful manner in the limited amount of space of each widget.

Thus, at operation 910, the widget content rules system 710 determines if the number of search results of a particular type includes a single search result. For example, for a widget of the type alerts (“alert widget”), the widget content rules system 710 may review the search results and determine a number of search results that provide alert related information. If the widget content rules system 710 determines that only a single search result pertains to alert related information, the widget content rules system, at operation 915, concludes that a detailed view of the single search result may be presented within the alert widget. The information that is included in the detailed view may be pre-programmed within the widget content rules system 710. For example and continuing with the alert example above, in some embodiments, the widget content rules system 710 may include the identity of the entity that is generating the alert, any data related to the alert, such as when the alert generated, the criticality of the alert, the type of alert, etc. An example of a widget showing a detailed view is shown in FIG. 10A, discussed below.

Upon identifying the manner of displaying the search results on the widget (e.g., the alert widget), the process 900 ends at operation 920 and returns to the operation 910 to start the analysis for the next widget to be activated.

If at the operation 910, the widget content rules system 710 determines that a number of search results of a particular type is greater than one, then at operation 925, the widget content rules system determines whether the number of those search results is greater than a first threshold. The first threshold may be pre-determined and pre-defined within the widget content rules system 710 and may correspond to a large number of search results of the particular type. For example, if the widget content rules system 710 determines that the search results have a large number of alert related results (e.g., the number of alert related results is greater than the first threshold), then the widget content rules system defines the view of the alert widget to be a visual or pictorial view.

At operation 930, the widget content rules system 710 organizes the alert related search results in a visual or pictorial view. The visual or pictorial view that is used may be pre-defined and pre-programmed within the widget content rules system 710. The visual or pictorial view may be any of a variety of graphs, charts, diagrams, or another form that displays an aggregation of information in a compact form. In some embodiments, the type of visual or pictorial view to use may be determined based upon a type of the search results. For example, the widget content rules system 710 may be programmed to display a large number of alert related search results in a bar graph, while a large number of metric related search results in a scatter plot or line graph, and so on. In other embodiments, the widget content rules system 710 may be programmed to determine the visual or pictorial view based on a number of the search results. For example, the widget content rules system 710 may be programmed to display a graph if the large number of search results exceeds a first number, a pie chart if the large number of search results exceeds a second number, and so on. Thus, the type of visual or pictorial view to use for the search results may vary from one embodiment to another. An example of a widget showing the search results in a visual or pictorial view is discussed in FIG. 10B below.

Upon determining the visual or pictorial view of the large number of search results at the operation 930, the process ends at the operation 920 and returns to the operation 910 to evaluate the next widget. If at the operation 925, the widget content rules system 710 determines that the number of search results of a particular type do not exceed the first threshold, then the widget content rules system may conclude that the number of search results is a small number. In other embodiments, a second threshold for what constitutes a small number may be programmed within the widget content rules system 710. Upon determining that the number of search results of a particular type is a small number, the widget content rules system 710 determines that the search results are to be displayed in a list view at operation 935. In a list view, the widget content rules system 710 provides a simple listing or tabular arrangement of all the search results of the particular type. The widget content rules system 710 may include some additional information, such as identity of the entity generating the alert, with each list item. The additional information that is included may be less than what is included in the detailed view but more than what is included in the visual view. An example of a widget showing the search results in a list view is shown in FIG. 10C below.

Again, the process ends at the operation 920 and returns to the operation 910 for evaluating the next widget. When all the widgets to be activated have been analyzed and their respective views determined, the search results are displayed on the display interface 320, as discussed at the operation 825 above.

Referring now FIGS. 10A-10C, example screenshots of a search console 1000 are shown, in accordance with some embodiments of the present disclosure. The search console 1000 includes a search interface 1005 having a search box 1010 and a search button 1015 for sending search queries received via the search box to the back-end system (e.g., the back-end system 310). The search console 1000 also includes a display interface 1020 having widgets 1025, 1030, 1035, 1040, 1045, and 1050 that display search results retrieved in response to a search query entered via the search interface 1005. The display interface 1020 also includes an organization tab 1055 to further facilitate organization of the search results. For example, as shown, a summary tab 1060 displays the widgets 1025-1050. A user may interact with other tabs in the organization tab 1055 to view specific information.

In some embodiments, the display interface 1020 may include other options and filters 1065 to further organize and view the search results, thereby providing additional mechanisms to view the search results and customize the display interface. Thus, the search console 1000 may be organized in a variety of ways as desired.

Referring now specifically to FIG. 10A, the widget 1035 shows a detailed view of the alert widget. As discussed above, the search results are shown in a detailed view when a single search result pertaining to that type of widget is retrieved. Thus, when a single search result is directed to alerts, the widget 1035, which is configured to display alert related information, displays the search result in a detailed view. Further, the detailed view of the widget 1035 has no bearing on the view of the other widgets (e.g., the widgets 1025, 1030, and 1040-1050). Thus, the view of each of the widgets 1025-1050 is independently determined.

FIG. 10B is same as FIG. 10A except for the widget 1035. The widget 1035 in FIG. 10B shows a visual view of the search results. As discussed above, when a large number of search results of a particular type are retrieved, the search results are displayed in a visual or a pictorial view. Thus, the widget 1035 shows a compilation of the large number of alert related search results in a visual or pictorial view. Similarly, FIG. 10C is same as FIGS. 10A and 10B except for the widget 1035, which is shown in a list view for a small number of search results of alert related information.

Thus, based upon the number of search results, the view or the manner of displaying the search results within the display interface 1020 may vary. It is to be understood that the size, shape, orientation, information displayed, as well as other features of the search console 1000, the search interface 1005, the display interface 1020, the organization tab 1055, the additional information 1060, and the widgets 1025-1050 are only examples and may vary from one embodiment to another.

Therefore, the present disclosure provides a search system for displaying search results in an organized and easily understandable manner. The search system is configured to adapt as the virtual computing system of which the search system is a part of changes. Thus, as more components are added to the virtual computing system, the search system dynamically adapts to automatically include those new components within the search capabilities without requiring manual, complicated, and time consuming steps. Further, as the size of the virtual computing system changes and a large volume of search results are retrieved, the dynamic search system is configured to adjust the manner in which the search results are displayed.

Further, although the present disclosure has been discussed in the context of a search system, in other embodiments, the present disclosure may be applicable in other application contexts that require adapting to changing conditions and/or require organization of information. Further, the various views that are discussed herein for displaying the search results may vary in other embodiments. For example, although a detailed view is used for a single search result, a visual view is used for a large number of search results, and a list view is used for a small number of search results, one or more of these vies may vary as desired in other embodiments.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality, and any two components capable of being so associated can also be viewed as being “operably couplable,” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, unless otherwise noted, the use of the words “approximate,” “about,” “around,” “substantially,” etc., mean plus or minus ten percent.

The foregoing description of illustrative embodiments has been presented for purposes of illustration and of description. It is not intended to be exhaustive or limiting with respect to the precise form disclosed, and modifications and variations are possible in light of the above teachings or may be acquired from practice of the disclosed embodiments. It is intended that the scope of the invention be defined by the claims appended hereto and their equivalents.

1. A method comprising:
activating, a widget that satisfies a condition based on a search result associated with a search query
determining, a view for the widget based upon the search result; and
displaying, the activated widget on a user interface and displaying the search result within the activated widget according to the view.

2. The method of claim 1, wherein the condition comprises an entity type identified from the search result, and wherein the widget that is suitable for displaying the entity type is activated.

3. The method of claim 1, wherein the condition comprises activating a state of a virtual computing system as identified from the search result, and wherein the widget that is suitable for displaying the state of the virtual computing system is activated.

4. The method of claim 1, wherein the condition comprises a particular type of the search result, and wherein the widget that is suitable for displaying the particular type of the search result is activated.

5. The method of claim 1, further comprising
defining, the view of the widget as a detailed view.

6. The method of claim 1,
wherein the search result comprises a plurality of search results, and wherein the view of the widget is a visual view based upon a number of the plurality of search results of a particular type being greater than a pre-determined threshold.

7. The method of claim 1,
wherein the search result comprises a plurality of search results, and wherein the view of the widget is a list view based upon a number of the plurality of search results of a particular type being greater than one and less than a pre-determined threshold.

8. The method of claim 1, further comprising:
receiving an indication of addition of a new service;
registering the new service with a search system in response to the indication, wherein the registering comprises identifying a keyword from the new service and automatically adding the keyword to a database of the search system; and
including data in the search result from the new service based upon the keyword.

9. The method of claim 8, further comprising installing the new service and associating the new service with the search system through the registering.

10. An apparatus comprising:
a processing unit having programmed instructions to:
activate a widget that satisfies a condition based on a search result associated with a search query;
determine a view for the widget based upon the search result and
display the activated widget on a user interface and display the search result within the activated widget according to the view.

11. The apparatus of claim 10, wherein the search result comprises a plurality of search results, and wherein the processing unit further comprises instructions to determine the view based upon a number of the plurality of search results of a particular type.

12. (canceled)

13. The apparatus of claim 10, wherein the view comprises a detailed view.

14. The apparatus of claim 11, wherein the view comprises a visual view based upon the number of the plurality of search results of the particular type being greater than a pre-determined threshold.

15. The apparatus of claim 11, wherein the view comprises a list view based upon the number of the plurality of search results of the particular type being greater than one and less than a pre-determined threshold.

16. The apparatus of claim 10, wherein the processing unit further comprises instructions to:
receive an indication of addition of a new service;
register the new service with a search system in response to the indication and identify a keyword from the new service,
automatically associate the keyword with the search system to register the new service; and
include data from the new service in the search result based upon the keyword.

17. The apparatus of claim 16, wherein the processing unit further comprises instructions to install the new service and associate the new service with the search system through the registration.

18. A non-transitory computer readable media with computer-executable instructions embodied thereon that, when executed by a processor of a search system, cause the search system to perform a process comprising:
activating a widget that satisfies a condition based on a search result associated with a search query;
determining a view for the widget based upon the search result and
displaying the activated widget on a search console and displaying the search result within the activated widget according to the view.

19. The non-transitory computer readable media of claim 18, wherein the view is one of a detailed view, a visual view, and a list view.

20. The non-transitory computer readable media of claim 18, wherein the processor automatically includes data in the search result from a new service associated with the search system.
